(19) United States
(12) Patent Application Publication
(10) Pub. No.: US 2026/0300658 A1
(43) Pub. Date: Oct. 1, 2026

(54) ADAPTIVE MODE SWITCHING OF REMOTE TAG READER

(71) Applicant: QUALCOMM Incorporated, San Diego, CA (US)

(72) Inventors: Sheng-Yuan TU, San Diego, CA (US); Venkatraman RAJAGOPALAN, San Diego, CA (US); Scott HOOVER, Del Mar, CA (US); Kiran PATIL, San Diego, CA (US); Bhupesh Manoharlal UMATT, San Diego, CA (US); Jayesh BATHIJA, San Diego, CA (US)

(21) Appl. No.: 19/091,560

(22) Filed: Mar. 26, 2025

(51) Int. Cl. G06K 7/10

(52) U.S. Cl. CPC G06K 7/10366

(57) ABSTRACT

A method of wireless communication performed by a remote tag reader (RTR) comprises, communicating with one or more tags based on one or more first parameters associated with a first communication mode, wherein the one or more first parameters comprise a first backscatter link frequency (BLF), a first number of subcarrier cycles per symbol, or any combination thereof, determining a second communication mode for communicating with the one or more tags based on a reply rate or a reply power associated with the first communication mode, and sending, to the one or more tags, one or more second parameters associated with the second communication mode, wherein the one or more second parameters comprise a second BLF, a second number of subcarrier cycles per symbol, or any combination thereof.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a remote tag reader (RTR) comprises: determining a communication mode for communicating with one or more remote tags based on: one or more activity levels of one or more radios associated with the RTR; an amount of interference determined by the RTR; a type of RTR procedure; or any combination thereof; sending, to the one or more tags, one or more parameters associated with the determined communication mode, wherein the one or more parameters indicate a backscatter link frequency (BLF), a number of subcarrier cycles per symbol, or any combination thereof; and communicating with the one or more tags based on the determined communication mode.

In an aspect, a remote tag reader (RTR) comprises: one or more memories; one or more transceivers; and one or more processors communicatively coupled to the one or more memories and the one or more transceivers, the one or more processors, either alone or in combination, configured to: determine a communication mode for communicating with one or more remote tags based on: one or more activity levels of one or more radios associated with the RTR; an amount of interference determined by the RTR; a type of RTR procedure; or any combination thereof; send, via the one or more transceivers, to the one or more tags, one or more parameters associated with the determined communication mode, wherein the one or more parameters indicate a backscatter link frequency (BLF), a number of subcarrier cycles per symbol, or any combination thereof; and communicate with the one or more tags based on the determined communication mode.

In an aspect, a remote tag reader (RTR) comprises: means for determining a communication mode for communicating with one or more remote tags based on: one or more activity levels of one or more radios associated with the RTR; an amount of interference determined by the RTR; a type of RTR procedure; or any combination thereof; means for sending, to the one or more tags, one or more parameters associated with the determined communication mode, wherein the one or more parameters indicate a backscatter link frequency (BLF), a number of subcarrier cycles per symbol, or any combination thereof; and means for communicating with the one or more tags based on the determined communication mode.

In an aspect, a non-transitory computer-readable medium stores computer-executable instructions that, when executed by a remote tag reader (RTR), cause the RTR to: determine a communication mode for communicating with one or more remote tags based on: one or more activity levels of one or more radios associated with the RTR; an amount of interference determined by the RTR; a type of RTR procedure; or any combination thereof; send, to the one or more tags, one or more parameters associated with the determined communication mode, wherein the one or more parameters indicate a backscatter link frequency (BLF), a number of subcarrier cycles per symbol, or any combination thereof; and communicate with the one or more tags based on the determined communication mode.

In an aspect, a method of wireless communication performed by a remote tag reader (RTR) comprises: communicating with one or more tags based on one or more first parameters associated with a first communication mode, wherein the one or more first parameters comprise a first backscatter link frequency (BLF), a first number of subcarrier cycles per symbol, or any combination thereof; determining a second communication mode for communicating with the one or more tags based on a reply rate or a reply power associated with the first communication mode; and sending, to the one or more tags, one or more second parameters associated with the second communication mode, wherein the one or more second parameters comprise a second BLF, a second number of subcarrier cycles per symbol, or any combination thereof.

In an aspect, a remote tag reader (RTR) comprises: one or more memories; one or more transceivers; and one or more processors communicatively coupled to the one or more memories and the one or more transceivers, the one or more processors, either alone or in combination, configured to: communicate with one or more tags based on one or more first parameters associated with a first communication mode, wherein the one or more first parameters comprise a first backscatter link frequency (BLF), a first number of subcarrier cycles per symbol, or any combination thereof; determine a second communication mode for communicating with the one or more tags based on a reply rate or a reply power associated with the first communication mode; and send, via the one or more transceivers, to the one or more tags, one or more second parameters associated with the second communication mode, wherein the one or more second parameters comprise a second BLF, a second number of subcarrier cycles per symbol, or any combination thereof.

In an aspect, a remote tag reader (RTR) comprises: means for communicating with one or more tags based on one or more first parameters associated with a first communication mode, wherein the one or more first parameters comprise a first backscatter link frequency (BLF), a first number of subcarrier cycles per symbol, or any combination thereof; means for determining a second communication mode for communicating with the one or more tags based on a reply rate or a reply power associated with the first communication mode; and means for sending, to the one or more tags, one or more second parameters associated with the second communication mode, wherein the one or more second parameters comprise a second BLF, a second number of subcarrier cycles per symbol, or any combination thereof.

In an aspect, a non-transitory computer-readable medium stores computer-executable instructions that, when executed by a remote tag reader (RTR), cause the RTR to: communicate with one or more tags based on one or more first parameters associated with a first communication mode, wherein the one or more first parameters comprise a first backscatter link frequency (BLF), a first number of subcarrier cycles per symbol, or any combination thereof; determine a second communication mode for communicating with the one or more tags based on a reply rate or a reply power associated with the first communication mode; and send, to the one or more tags, one or more second parameters associated with the second communication mode, wherein the one or more second parameters comprise a second BLF, a second number of subcarrier cycles per symbol, or any combination thereof.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A and 3B are simplified block diagrams of several sample aspects of components that may be employed in a user equipment (UE) and a remote tag reader (RTR), respectively, and configured to support communications as taught herein.

FIGS. 4A and 4B illustrate examples of communication modes of an RTR.

FIG. 5 illustrates an example of a tag read operation 500, according to aspects of the disclosure.

FIG. 6 illustrates a method for selecting and/or modifying a communication mode and/or physical layer configuration associated with one or more RTR operations, in accordance with aspects of the disclosure.

FIGS. 7 to 8 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to short-range communication. Some aspects more specifically relate to adaptive mode-switching of a remote tag reader (RTR). In some examples, an RTR determines a communication mode for communicating with one or more tags based on one or more activity levels of one or more radios associated with the RTR reader, an amount of interference determined by the RTR reader, and/or a type of RTR procedure. The communication mode is associated with one or more parameters indicating a backscatter link frequency (BLF), a number of subcarrier cycles per symbol (M), or any combination thereof. The RTR sends the one or more parameters to one or more tags and communicates with the tags based on the one or more parameters.

Particular aspects of the subject matter described in this disclosure can be implemented to realize one or more of the following potential advantages. In some examples, by determining the communication mode based on the factors described above, the described techniques can be used to balance tradeoffs between resource consumption by the RTR and performance of an RTR operation. For example, in accordance with aspects of the disclosure, better performance (e.g., faster read rate, higher tag detection ratio) may be increased by setting and/or modifying the one or more parameters. In some examples, by determining the communication mode based on the factors described above, the described techniques can be used to improve the efficiency of a device (e.g., a user equipment (UE)) that includes one or more remote-reading antennas/radios and one or more other antennas/radios (e.g., WWAN, WLAN, Bluetooth, etc.). For example, in accordance with aspects of the disclosure, the device can select and/or modify the one or more parameters so as to allocate power resources and/or computational resources to an RTR operation in a manner that does not limit non-RTR operations of the device. For example, in accordance with aspects of the disclosure, the device can select and/or modify the one or more parameters so as to prevent interference with the one or more other antennas/radios of the device.

In some examples, an RTR communicates with one or more tags based on a first communication mode (e.g., one or more first parameters associated with M and/or BLF), and determines a second communication mode (e.g., one or more second parameters) for communicating with the one or more tags based on a reply rate and/or a reply power associated with the first communication mode. The RTR sends the one or more second parameters to the one or more tags.

Particular aspects of the subject matter described in this disclosure can be implemented to realize one or more of the following potential advantages. In some examples, by determining the second communication mode based on reply rate and/or reply power (and sending the one or more second parameters to the one or more tags), the described techniques can be used to increase performance of an RTR operation (e.g., modify the communication mode so as to increase the reply rate and/or reply power), or by increasing the efficiency of the device (e.g., modify the communication mode so as to decrease power consumption).

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs ca communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

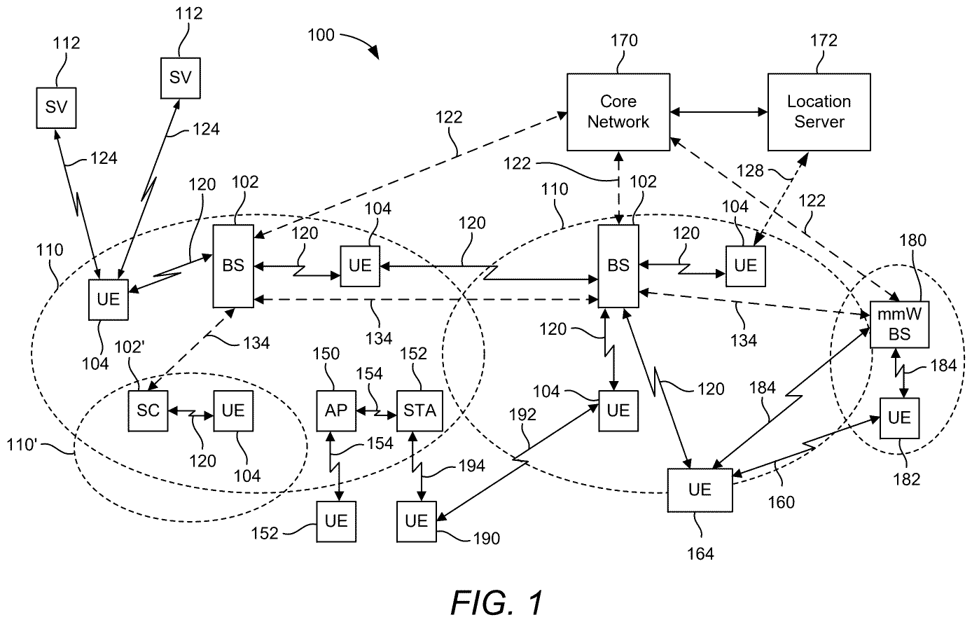

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mm W/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mm W base station 180 over a mmW communication link 184. For example, the macro cell base station 102 may support a PCell and one or more SCells for the UE 164 and the mm W base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

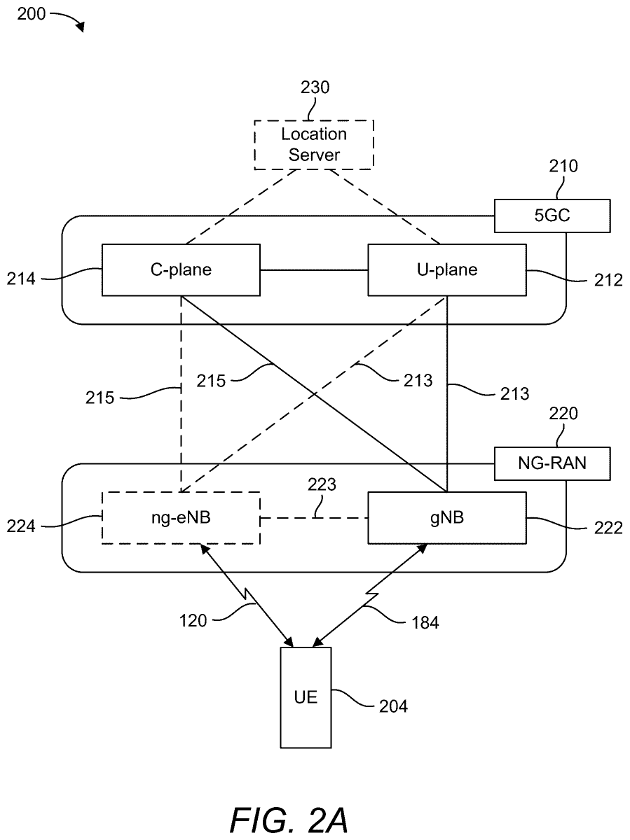

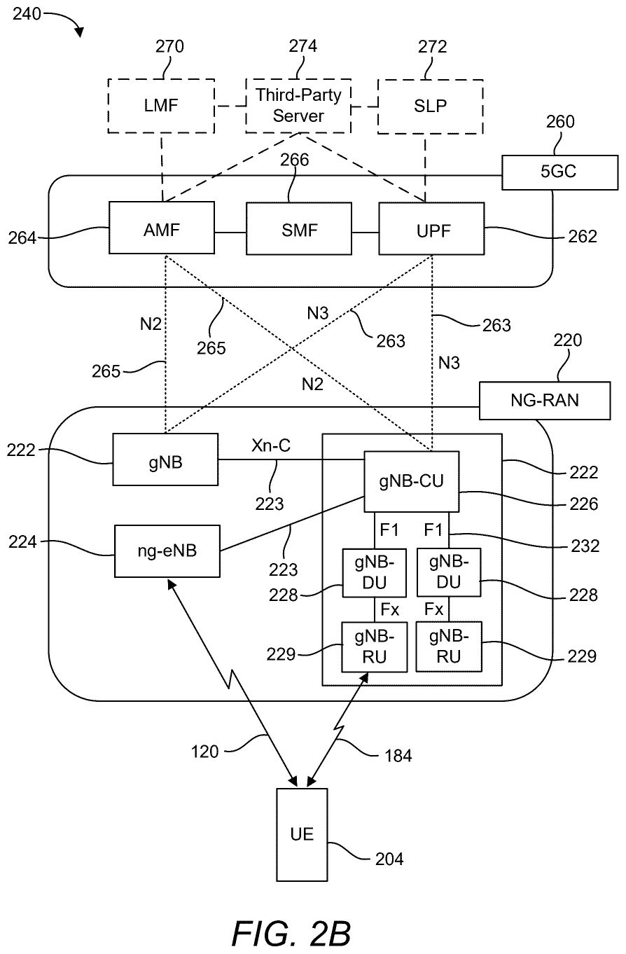

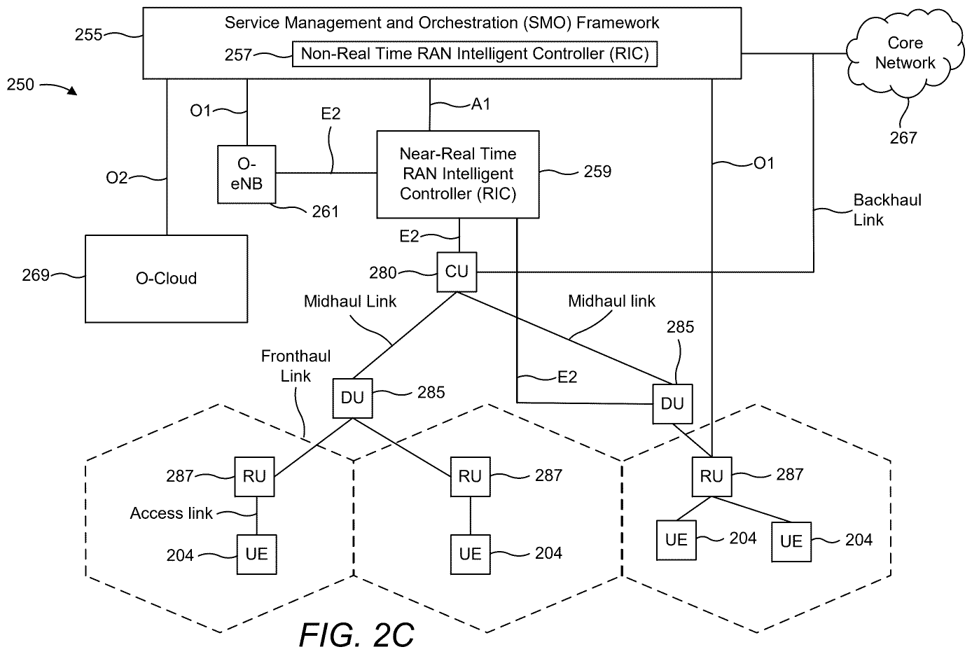

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that ca communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit ca communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 ca communicate with a hardware aspect of a 4G RAN, such as an open eNB (O-eNB) 261, via an O1 interface. Additionally, in some implementations, the SMO Framework 255 ca communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

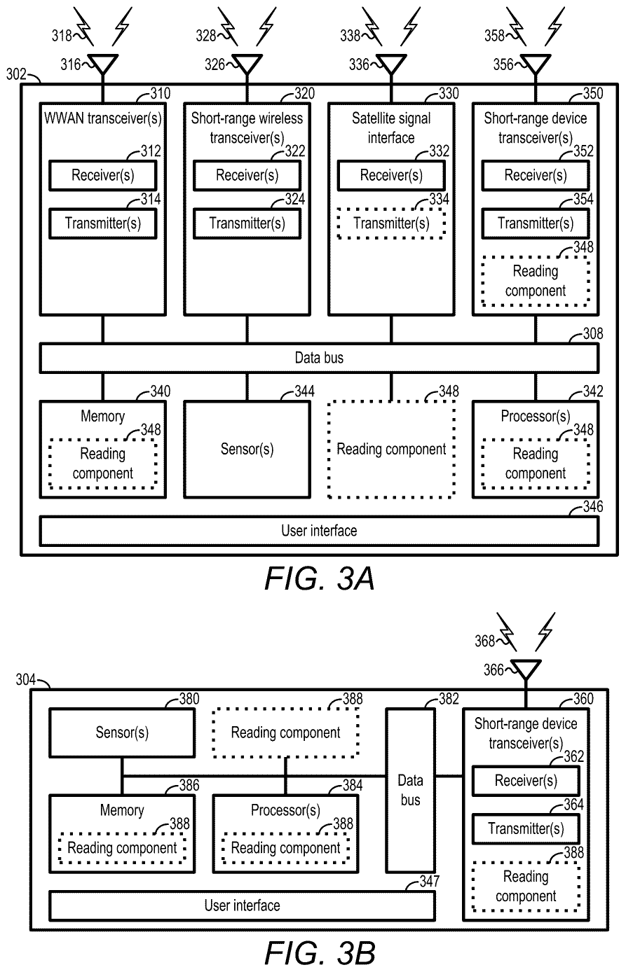

FIGS. 3A and 3B illustrate several example components (represented by corresponding blocks) that may be incorporated into a remote tag reader, according to aspects of the disclosure.

A remote tag reader (RTR) may include one or more antenna/radio devices associated with a low probability of interference with other antenna/radio services. For example, due to the short transmission range associated with the RTR, the RTR may transmit at low power (e.g., may not be capable of transmitting at high power). Any device that is capable of lower-power transmission may be considered as an RTR. For example, a UE (e.g., UE 302 illustrated in FIG. 3A) may be capable of operating as an RTR (e.g., may comprise an remote-reading antenna/radio associated with low-power transmission and/or other RTR functionality), but may also be capable of operating as a cellular device, wireless access point, etc. Other RTRs (e.g., RTR 304 illustrated in FIG. 3B) may not be capable of high-power transmission (e.g., due to hardware constraints). Examples of RTRs include radio frequency identification (RFID) devices (e.g., RFID readers, a UEs with RFID reader functionality, etc.). Other examples of RTRs include access control devices (e.g., door and gate openers), alarms and movement detectors, closed-circuit television (CCTV) systems, cordless audio devices (e.g., wireless microphones), local area networks (LANs), medical implants, remote control devices, road transport telematics, telemetry devices, etc.

UE 302 (which may correspond to any of the UEs described herein) and RTR 304 (which may correspond to any of the RTRs described herein) may be configured to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 includes one or more wireless wide area network (WWAN) transceivers 310, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on), respectively, and, conversely, for receiving and decoding signals 318 (e.g., messages, indications, information, pilots, and so on), in accordance with the designated RAT. Specifically, the one or more WWAN transceivers 310 include one or more transmitters 314, for transmitting and encoding signals 318, and one or more receivers 312, for receiving and decoding signals 318.

The UE 302 includes, at least in some cases, one or more remote-reading wireless transceivers 320. The one or more remote-reading wireless transceivers 320 may be connected to one or more antennas 326, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The one or more remote-reading wireless transceivers 320 may be variously configured for transmitting and encoding signals 328 (e.g., messages, indications, information, and so on), and, conversely, for receiving and decoding signals 328 (e.g., messages, indications, information, pilots, and so on), in accordance with the designated RAT. Specifically, the one or more remote-reading wireless transceivers 320 include one or more transmitters 324, for transmitting and encoding signals 328, and one or more receivers 322, for receiving and decoding signals 328. As specific examples, the one or more remote-reading wireless transceivers 320 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 also includes, at least in some cases, one or more satellite signal interface 330, which includes one or more satellite signal receivers 332, and may optionally include one or more satellite signal transmitters 334.

The one or more satellite signal receivers 332 may be connected to one or more antennas 336, and may provide means for receiving and/or measuring satellite positioning/communication signals 338. Where the one or more satellite signal receivers 332 are satellite positioning system receivers, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the one or more satellite signal receivers 332 are non-terrestrial network (NTN) receivers, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine a location of the UE 302 using measurements obtained by any suitable satellite positioning system algorithm.

The optional satellite signal transmitter(s) 334, when present, may be connected to the one or more antennas 336, and may provide means for transmitting satellite positioning/communication signals 338. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 are NTN transmitters, the satellite positioning/communication signals 338 may be communication signals (e.g., carrying control and/or user data) originating from a 5G network. The satellite signal transmitter(s) 334 may comprise any suitable hardware and/or software for transmitting satellite positioning/communication signals 338. The satellite signal transmitter(s) 334 may request information and operations as appropriate from the other systems.

The UE 302 and the RTR 304 each include one or more RTR transceivers 350 and 360, respectively, providing means for communicating (e.g., means for transmitting, means for receiving, etc.) with other network entities (e.g., other UEs, other RTRs, one or more transponders, one or more tags, etc.).

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, RTR 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, RTR 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., one or more WWAN transceivers 310, one or more remote-reading wireless transceivers 320) may also include a network listen module (NLM) or the like for performing various measurements.

As used herein, the various wireless transceivers and wired transceivers may generally be characterized as “a transceiver,” “at least one transceiver,” or “one or more transceivers.” As such, whether a particular transceiver is a wired or wireless transceiver may be inferred from the type of communication performed.

The UE 302 and RTR 304 also include other components that may be used in conjunction with the operations as disclosed herein. The UE 302 and RTR 304 include one or more processors 342 and 384, respectively, for providing functionality relating to, for example, wireless communication, and for providing other processing functionality. The processors 342 and 384 may therefore provide means for processing, such as means for determining, means for calculating, means for receiving, means for transmitting, means for indicating, etc. In an aspect, the processors 342 and 384 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302 and RTR 304 include memory circuitry implementing memories 340 and 386 (e.g., each including a memory device), respectively, for maintaining information (e.g., information indicative of reserved resources, thresholds, parameters, and so on). The memories 340 and 386 may therefore provide means for storing, means for retrieving, means for maintaining, etc. In some cases, the UE 302 and RTR 304 may include reading component 348 and 388, respectively. The reading component 348 and 388 may be hardware circuits that are part of or coupled to the processors 342 and 384, respectively, that, when executed, cause the UE 302 and RTR 304 to perform the functionality described herein. In other aspects, the reading component 348 and 388 may be external to the processors 342 and 384 (e.g., part of a modem processing system, integrated with another processing system, etc.). Alternatively, the reading component 348 and 388 may be memory modules stored in the memories 340 and 386, respectively, that, when executed by the processors 342 and 384 (or a modem processing system, another processing system, etc.), cause the UE 302 and RTR 304 to perform the functionality described herein. FIG. 3A illustrates possible locations of the reading component 348, which may be, for example, part of the one or more RTR transceivers 350, the memory 340, the one or more processors 342, or any combination thereof, or may be a standalone component. FIG. 3B illustrates possible locations of the reading component 388, which may be, for example, part of the one or more RTR transceivers 360, the memory 386, the one or more processors 384, or any combination thereof, or may be a standalone component.

The UE 302 and RTR 304 may include one or more sensors 344 and one or more sensors 380, respectively, coupled to the one or more processors 342 and one or more processors 384, respectively, to provide means for sensing or detecting movement and/or orientation information that is independent of motion data derived from signals received by the one or more WWAN transceivers 310, the one or more remote-reading wireless transceivers 320, satellite signal interface 330, and/or RTR transceivers 350. By way of example, the one or more sensors 344 and one or more sensors 380 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the one or more sensors 344 and one or more sensors 380 may include a plurality of different types of devices and combine their outputs in order to provide motion information. For example, the one or more sensors 344 and one or more sensors 380 may use a combination of a multi-axis accelerometer and orientation sensors to provide the ability to compute positions in two-dimensional (2D) and/or three-dimensional (3D) coordinate systems.

In addition, the UE 302 and RTR may include a user interface 346 and user interface 347, respectively, providing means for providing indications (e.g., audible and/or visual indications) to a user and/or for receiving user input (e.g., upon user actuation of a sensing device such a keypad, a touch screen, a microphone, and so on).

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by, for example, a base station. These soft decisions may be based on channel estimates computed by a channel estimator. The soft decisions are then decoded and de-interleaved to recover the data and control signals that were originally transmitted by a base station on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by a base station, the one or more processors 342 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

For convenience, the UE 302 and RTR 304 are shown in FIGS. 3A and 3B as including various components that may be configured according to the various examples described herein. It will be appreciated, however, that the illustrated components may have different functionality in different designs. In particular, various components in FIGS. 3A to 3B are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the remote-reading wireless transceiver(s) 320 (e.g., cellular-only, etc.), or may omit the satellite signal interface 330, or may omit the sensor(s) 344, and so on. For brevity, illustration of the various alternative configurations is not provided herein, but would be readily understandable to one skilled in the art.

The various components of the UE 302 and RTR 304 may be communicatively coupled to each other over data buses 308 and 382, respectively. In an aspect, the data buses 308 and 382 may form, or be part of, a communication interface of the UE 302 and RTR 304, respectively. For example, where different logical entities are embodied in the same device (e.g., gNB and location server functionality incorporated into the same RTR 304), the data buses 308 and 382 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 356 may be implemented by processor and memory component(s) of the UE 302 (e.g., by execution of appropriate code and/or by appropriate configuration of processor components). Similarly, some or all of the functionality represented by blocks 360 to 388 may be implemented by processor and memory component(s) of the RTR 304 (e.g., by execution of appropriate code and/or by appropriate configuration of processor components). For simplicity, various operations, acts, and/or functions are described herein as being performed “by a UE,” “by an RTR,” etc. However, as will be appreciated, such operations, acts, and/or functions may actually be performed by specific components or combinations of components of the UE 302, RTR 304, etc., such as the processors 342, 384, the transceivers 310, 320, 330, 350, and 360, the memories 340 and 386, the reading component 348 and 388, etc.

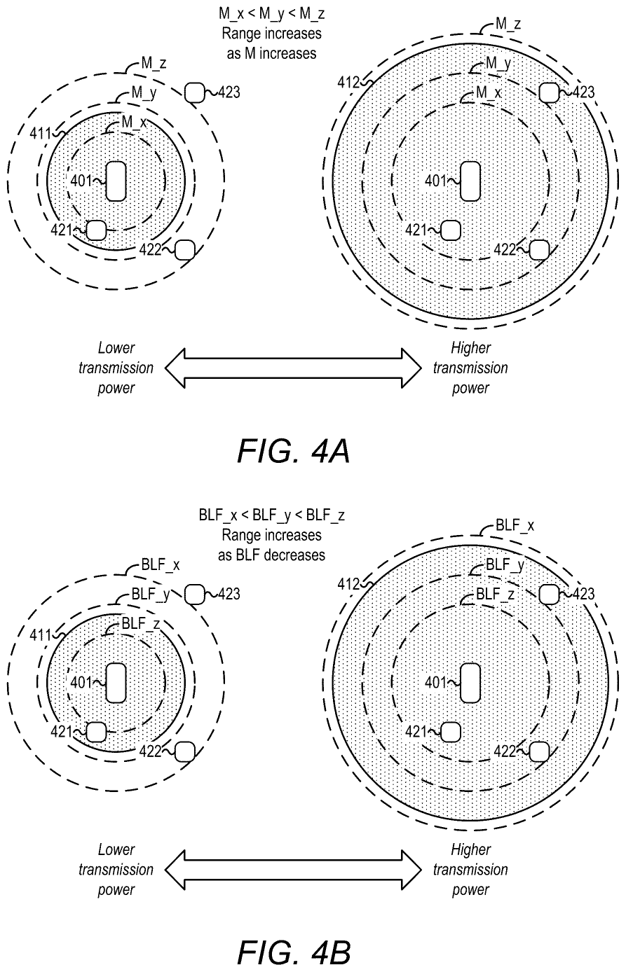

FIGS. 4A and 4B illustrate examples of communication modes of an RTR. The communication scenario may be a remote-reading communication scenario associated with a remote tag reader (RTR) and one or more transponders or tags. In the example, the communication scenario involves a UE or RTR, illustrated as an RFID reader 401. It will be understood that the functionality of the RFID reader 401 may be implemented in any of the UEs and/or RTRs described herein (e.g., the UE 302 and/or RTR 304 described previously). The RFID reader 401 may communicate with the one or more transponders or tags, illustrated as an RFID tag 421, an RFID tag 422, and an RFID tag 423.

In an example, the RFID tags 421, 422, 423 are passive RFID tags which use received energy of a forward link transmission (e.g., transmitted by RFID reader 401) to generate a reverse link transmission (e.g., backscatter). Other types of RFID tags exist, including active RFID tags, which have a dedicated power source to support the reverse link transmission, and semi-passive RFID tags, which have a dedicated power source to assist with the reverse link transmission. The techniques described in the present disclosure may be implemented with any type of tag.

In the examples of FIGS. 4A and 4B, RFID reader 401 transmits (e.g., broadcasts) via the forward link. The range of the forward link transmission may depend on the transmission power of the forward link transmission. In both of FIGS. 4A and 4B, the left-hand side corresponds to low-power transmissions and the right-hand side corresponds to high-power transmissions (i.e., higher-power transmissions than the transmissions illustrated at left). The low-power transmissions have a forward link range 411 and the high-power transmissions have a forward link range 412. The forward link ranges 411, 412 are represented as shaded circles. It will be understood that the forward link range 412 is larger than the forward link range 411 by virtue of the higher transmission power associated with the forward link range 412. The extent of the forward link ranges 411, 412 may be affected by other factors, for example, tag sensitivity.

An RFID tag that is within the range of the forward link may be configured to transmit a reply via the reverse link. In the case of a passive tag, the RFID reader 401 may provide the energy that is used to transmit the reply. For example, to detect a reply from RFID tag 421 (e.g., receive a reverse link transmission from RFID tag 421), the RFID reader 401 may transmit via the forward link with transmission power in excess of what is necessary to merely reach RFID tag 421. Upon reaching RFID tag 421, the power of the transmitted signal may be diminished, but the remaining power may still be sufficient to enable RFID tag 421 to transmit a reply that reaches RFID reader 401.

Accordingly, the transmission power of the forward link is a factor for determining the range at which RFID reader 401 can reliably detect a reply from RFID tags 421, 422, 423, etc. In the examples of FIGS. 4A and 4B, a reply from a tag may be received if the tag is within the forward link range (e.g., forward link range 411 or forward link range 412, depending on the transmission power).

Whether RFID reader 401 receives a reply from a tag also depends on the range of the reverse link transmission. Even if a transmission in the forward link reaches the tag, the reply will not be received unless the reverse link reaches RFID reader 401. As noted above, the transmission power in the forward link (and the distance between the tag and the reader) may impact the range of the reverse link. As will be discussed in greater detail below, the range of the reverse link may be affected by a communication mode of the tag. In some implementations, the communication mode may be referred to as a radio frequency (RF) mode. The communication mode of the tag may be characterized by a particular number of subcarrier cycles per symbol (M), a particular backscatter link frequency (BLF), and/or one or more other factors.

In FIGS. 4A and 4B, several reverse links are illustrated, each corresponding to a different communication mode. The extent of each reverse link is illustrated as an unshaded circle with a dashed line. Each illustration contains three dashed circles with three different radiuses, representing reverse links with different ranges. The different ranges correspond to different communication modes of the tag. In FIG. 4A, the different communication modes of the tag correspond to different values of M (e.g., with other factors such as BLF held constant). In FIG. 4B, the different communication modes of the tag correspond to different values of BLF (e.g., with other factors such as M held constant). As will be discussed in greater detail below, FIGS. 4A and 4B illustrate that the range of the reverse link may increase as M increases and/or as BLF decreases.

In an example, RFID reader 401 performs a read and/or inventory operation involving one or more tags. Whether the RFID reader 401 reads (for example) RFID tag 422 may depend on (1) whether the forward link transmission reaches RFID tag 422 and (2) whether the reply of RFID tag 422 reaches RFID reader 401. As per the illustrated example of FIGS. 4A and 4B, the RFID reader 401 may read RFID tag 422 if (1) RFID tag 422 is within the shaded circle representing the range of the forward link and (2) RFID tag 422 is within the dashed circle representing the range of the reverse link. If RFID tag 422 is within both circles, then RFID reader 401 may read RFID tag 422.

As noted above, FIG. 4A illustrates different communication modes corresponding to different values of M.

When a higher number of subcarrier cycles per symbol is used, a transmission duration per data bit is increased relative to a lower number of subcarrier cycles per symbol. As a result, the transmission is less susceptible to noise, because the bit sequence may still be effectively communicated.

FIG. 4A illustrates the various detection ranges associated with various values of M, denoted as Mₓ, M_{y}, and M_{z}. The detection ranges are illustrated as dashed lines. In the illustrated example, Mₓ<M_{y}<M_{z}. In an example, Mₓ=1, M_{y}=2, and M_{z}=4. For a low-power scenario (left), Mₓ is barely sufficient to reliably detect RFID tag 421. Increasing from Mₓ to M_{y} increases the detection range to easily include RFID tag 421, but RFID tag 422 is still beyond detection. Further increasing from M_{y} to M_{z} is sufficient to reliably detect RFID tag 421 and RFID tag 422, but RFID tag 423 is still beyond detection. In the high-power scenario (right), Mₓ only detects RFID tag 421; M_{y} detects RFID tag 421 and RFID tag 422; and M_{z} suffices to reliably detect all of the RFID tags 421, 422, 423.

As shown in FIG. 4B, different communication modes may (additionally or alternatively) correspond to different BLFs, denoted as BLFₓ, BLF_{y}, and BLF_{z}. In particular, decreasing BLF may increase a range of the reverse link. BLF corresponds to a frequency at which the tag transmits a reply. As an example, BLF may be in the range of forty kilohertz (40 kHz) to six-hundred and forty kilohertz (640 kHz). It will be understood that for a given transmission power level, signals transmitted with a low BLF have a longer transmission duration per data unit and may be successfully received at greater distances than signal transmitted with a high BLF. For example, if the tag is power-limited, then the extent of the detection range can be increased by lowering the BLF of the reverse link transmission.

In the illustrated example, BLFₓ<BLF_{y}<BLF_{z}. For a low-power scenario (left), BLF_{z} is barely sufficient to reliably detect RFID tag 421. Decreasing from BLF_{z} to BLF_{y} increases the detection range to easily include RFID tag 421, but RFID tag 422 is still beyond detection. Further decreasing from BLF_{y} to BLFₓ is sufficient to reliably detect RFID tag 421 and RFID tag 422, but RFID tag 423 is still beyond detection. In the high-power scenario (right), BLF_{z} only detects RFID tag 421; BLF_{y} detects RFID tag 421 and RFID tag 422; and BLFₓ suffices to reliably detect all of the RFID tags 421, 422, 423.

The selection of a communication mode may involve tradeoffs. For example, as noted above, increasing M and/or decreasing BLF can extend the detection range (e.g., RFID reader 401 achieves greater sensitivity). However, if the range is extended by increasing M and/or decreasing BLF, then the speed of the communication (e.g., read rate) may be reduced. For example, it will be understood that if M is increased from M=1 to M=4, four times as many bits are transmitted, which may take four times as long. Similarly, lower frequencies generally carry less data, so if BLF is decreased, replies may be more likely to be received, but they may not be received as quickly.

Accordingly, to increase the extent of the detection range, RFID reader 401 may increase the transmission power in the forward link. The tradeoff is that more power is consumed. Additionally or alternatively, a communication mode of one or more tags may be adjusted (e.g., by increasing M or decreasing BLF). The tradeoff is that the speed of communication may be reduced.

As a practical matter, a user may wish to increase or decrease the extent of the detection range. For example, in an environment with a high density of tags, a large detection range can precipitate an avalanche of replies. It will be understood that to reduce the extent of the detection range, the transmission power in the forward link may be reduced and/or the communication mode of one or more tags may be adjusted (e.g., by decreasing M or increasing BLF).

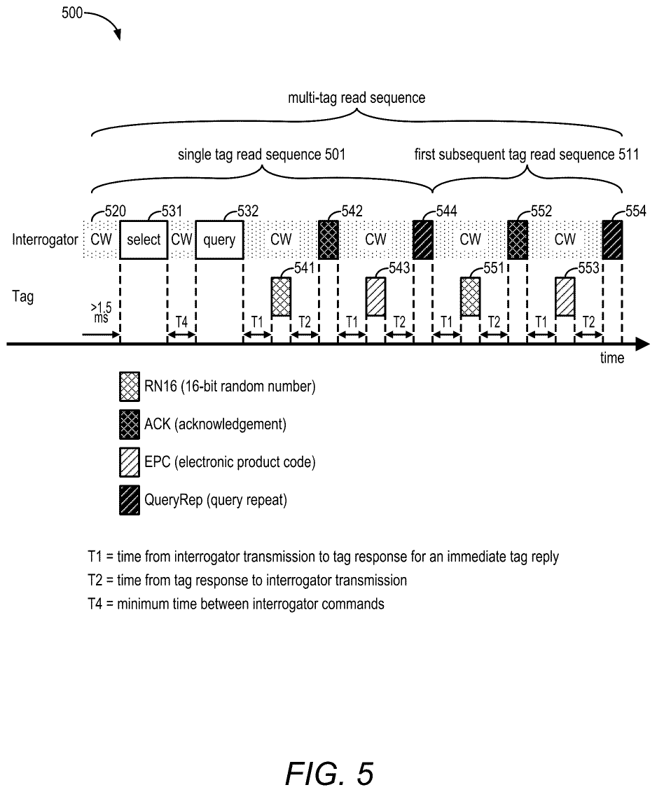

FIG. 5 illustrates an example of a tag read operation 500, according to aspects of the disclosure. The tag read operation 500 may involve an interrogator and one or more tags. The interrogator may correspond to any of the UEs and/or RTRs described in the present disclosure (e.g., the UE 302, the RTR 304, the RFID reader 401, etc.). The one or more tags may correspond to any of the tags and/or transponders described in the present disclosure (e.g., the RFID tags 421, 422, 423, etc.).

The tag read operation 500 may follow a particular protocol (e.g., an RFID protocol). The protocol may prescribe, for example, a sequence of particular messages, the type of message to be sent in response to a particular message, the timing for responding to the particular message, etc. The tag read operation 500 illustrated in FIG. 5 corresponds to a particular protocol, although it will be understood that the present disclosure may be implemented in other contexts (e.g., different message sequences, different timings, etc.).

During the tag read operation 500, the interrogator may transmit a continuous wave 520. In an example, the continuous wave 520 may be transmitted throughout the tag read operation 500, and may be used by one or more tags which receive continuous wave 520 as a power and/or energy source. The one or more tags may use the power and/or energy supplied by continuous wave 520 to transmit one or more replies to the interrogator (e.g., backscatter). In an example, the interrogator may superimpose one or more messages on top of the continuous wave 520.

The tag read operation 500 may involve one or more tag read sequences. The one or more tag read sequences may be referred to as an inventory round. In an example, a first tag read sequence 501 corresponds to a first tag, and each subsequent tag read sequence may correspond to a different tag. FIG. 5 illustrates a first subsequent tag read sequence 511 which may correspond to, for example, a second tag. Other subsequent tag read sequences (e.g., a second subsequent tag read sequence having the same structure) may follow the first subsequent tag read sequence 511.

The first tag read sequence 501 may include transmission, by the interrogator, of a select message 531 and a query message 532. The first tag read sequence 501 may begin with transmission of the continuous wave 520. In some implementations, the select message 531 may not be transmitted until continuous wave 520 has been transmitted for a certain amount of time. For example, a protocol of the tag read operation 500 may prescribe that the interrogator transmits continuous wave 520 for at least one and one-half milliseconds (1.5 ms) before transmitting select message 531. The transmission of continuous wave 520 may support pre-charging of one or more tags (e.g., one or more passive tags). Additionally or alternatively, the protocol may prescribe an amount of time T4 between transmission of select message 531 and query message 532. In the illustrated example, after transmission of select message 531 is complete, the interrogator waits for T4 to elapse before beginning to transmit query message 532.

The select message 531 may indicate one or more tags that are selected for the tag read operation 500. As an example, the interrogator may select a tag population (e.g., one or more particular tags) for reading and/or inventory, and select message 531 may comprise or consist of a select command. As another example, the interrogator may select a tag population for cryptographical challenge and/or authentication, and select message 531 may comprise a challenge command. As an example, to indicate which tags are selected, select message 531 may indicate a file type. A tag that receives select message 531 may determine whether it stores a file having the indicated file type. If the indicated file type is stored by the tag, then the tag determines that it has been selected by the interrogator. As another example, select message 531 may comprise a bit sequence (e.g., in a mask field) and may indicate a location in memory (e.g., in pointer and length fields). A tag that receives select message 531 may determine whether the bit sequence in the select message 531 matches the tag's memory at the indicated location. If there is a match, then the tag determines that it has been selected by the interrogator.

The query message 532 may, for example, initiate and/or specify an inventory round and/or a session associated with the inventory round. The inventory round (and/or session thereof) may comprise one or more tag read sequences. The inventory round may involve the one or more tags indicated by select message 531. The query message 532 may indicate (e.g., comprise a value indicating) the inventory round and/or session. The query message 532 may indicate a subset of the one or more tags indicated by 531. The query message 532 may indicate (e.g., comprise a value indicating) a slot count parameter (Q). The query message 532 may indicate (e.g., comprise a value indicating) a number of subcarrier cycles per symbol (M), a backscatter link frequency (BLF), or any combination thereof (e.g., a communication mode).

Each tag that receives query message 532 may select a random number. The random number may indicate a slot for communicating (or attempting to communicate) with the interrogator. The random number may function as a slot counter. As an example, a first tag may generate a first random number indicating to attempt communication with the interrogator in a first slot (e.g., during the first tag read sequence 501). One or more other tags (e.g., a second tag, a third tag, etc.) may generate other random numbers indicating to remain silent during the first slot and/or attempt communication in a later slot.

The number of bits of the random number may be indicated by the slot count parameter (Q). The random number may have sixteen or fewer bits (e.g., four bits). Each tag may load a respective random number into the tag's slot counter. The tag may enter a ‘reply’ state and/or attempt to communicate during first tag read sequence 501 if the generated number is zero (e.g., 0000). Any tag which generates a non-zero number (e.g., 0001 or 0010) may enter an ‘arbitrate’ state and/or remain silent during first tag read sequence 501.

The first tag (e.g., the tag that generates a particular random number, or is selected by some other technique) may respond to query message 532 by transmitting a random number message 541. The random number message 541 may comprise a random number generated by the first tag (e.g., the random number used loaded to the slot counter or a new random number). The random number may be, for example, sixteen bits (e.g., RN16). The protocol associated with tag read operation 500 may prescribe an amount of time T1 between reception of query message 532 and transmission of random number message 541. In the illustrated example, after reception of query message 532 is complete, the first tag waits for T1 to elapse before beginning to transmit query message 532. In some implementations, a reply that is sent after waiting for T1 to elapse may be considered as an immediate reply.

After receiving random number message 541, the interrogator may transmit an acknowledgement message 542. The acknowledgement message 542 may indicate, for example, the same random number that is indicated by random number message 541. The protocol associated with tag read operation 500 may prescribe an amount of time T2 between reception of random number message 541 and transmission of acknowledgement message 542. In the illustrated example, after reception of random number message 541 is complete, the interrogator waits for T2 to elapse before beginning to transmit acknowledgement message 542.

After receiving the acknowledgement message 542, the tag that transmitted the random number message 541 (e.g., the first tag) may respond by transmitting an EPC message 543 indicating the tag's electronic product code (EPC). Before transmitting EPC message 543, the first tag may wait for T1 to elapse. Upon reception of EPC message 543, the interrogator has obtained the EPC of the first tag and may be considered as having successfully read and/or inventoried the first tag.

After receiving EPC message 543, the interrogator may transmit a query repeat message 544. The query repeat message 544 may indicate, for example, the inventory round or session (e.g., using the same value that was indicated in query message 532). The actions described below (as being performed by the tags in response to the query repeat message 544) may be performed based on the query repeat message 544 indicating the same inventory round and/or session as the query message 532.

Upon reception of query repeat message 544, the first tag may consider itself as having been successfully read and/or inventoried. For example, the first tag may exit the ‘acknowledged’ state, enter a ‘ready’ state, and/or set an ‘inventoried’flag.

Other tags which receive the query repeat message 544 (e.g., the second tag and third tag) may decrement their respective slot counters (e.g., the second tag may decrement from 0001 to 0000 and the third tag may decrement from 0010 to 0001). Any tag with a slot counter equal to zero (e.g., the second tag) may exit the ‘arbitrate’ state and/or enter the ‘reply’ state. Any tag with a slot counter that is still non-zero (e.g., the third tag) may remain in the ‘arbitrate’ state and/or not enter the ‘reply’ state.

The first subsequent tag read sequence 511 may involve a non-inventoried tag and/or the tag that enters the ‘reply’ state (e.g., the second tag). The first subsequent tag read sequence 511 may follow a similar structure as the tag-specific portion of the first tag read sequence 501. The similar structure may involve similar messages and similar timings.

The second tag may transmit a random number message 551 (e.g., analogous to random number message 541). The random number message 551 may be transmitted based on the second tag being in a ‘reply’ state and/or the slot counter of the second tag (e.g., the slot counter being equal to zero). The random number message 551 may be transmitted in response to reception of query repeat message 544 (e.g., after time T1 has elapsed from reception of query repeat message 544).

The interrogator may transmit an acknowledgement message 552 (e.g., analogous to acknowledgement message 542). The acknowledgement message 552 may comprise the same random number as was included in the random number message 551. The acknowledgement message 552 may be transmitted in response to reception of query repeat message random number message 551 (e.g., after time T2 has elapsed from reception of random number message 551).

The second tag may transmit an EPC message 553 (e.g., analogous to EPC message 543). The EPC message 553 may be transmitted in response to reception of acknowledgement message 552 (e.g., after time T1 has elapsed from reception of random number message 551).

The interrogator may consider the second tag as having been inventoried based on reception of the EPC message 553. The interrogator may transmit a query repeat message 554 (e.g., analogous to query repeat message 544). The query repeat message 544 may be transmitted in response to reception of EPC message 553 (e.g., after time T2 has elapsed from reception of EPC message 553).

Upon reception of query repeat message 554, the second tag (e.g., the tag in the ‘acknowledged’ state) may consider itself as having been successfully read and/or inventoried. For example, the first tag may exit the ‘reply’ state, enter an ‘acknowledged’ state, and/or set an ‘inventoried’ flag.

Other tags which receive the query repeat message 554 (e.g., the third tag) may decrement their respective slot counters (e.g., the third tag may decrement from 0001 to 0000). Any tag with a slot counter equal to zero (e.g., the third tag) may exit the ‘arbitrate’ state and/or enter the ‘reply’ state. Accordingly, another subsequent tag read sequence similar to first subsequent tag read sequence 511 may commence (not illustrated in FIG. 4). The next subsequent tag read sequence may involve the third tag. Further subsequent tag read sequences may commence in the same manner until, for example, the inventory round and/or session is over.

Generally, the tag read operation 500 described above may be described as having an initial round-specific or session-specific messaging sequence (corresponding to select message 531 in the illustrated example), followed by one or more tag-specific messaging sequences corresponding to the first tag (query message 532 through EPC message 543) and (optionally) additional tag-specific durations corresponding to additional tags (query repeat message 544 through EPC message 553).

In an example, a single-tag read sequence may have a duration between one and two-tenths of a millisecond (1.2 ms) and fifty milliseconds (50 ms), not including a pre-charge duration that may last at least one and one-half of a millisecond (1.5 ms). In a multi-tag read sequence, each additional tag read sequence may have a duration between one and two-tenths of a millisecond (0.5 ms) to forty-one milliseconds (41 ms). The variation may be due to various factors, including selection of the communication mode. For example, if the number of subcarrier cycles per symbol (M) is raised and/or the backscatter link frequency (BLF) is reduced, then each message (e.g., random number message 541, acknowledgement message 542, etc.) may take longer to transmit. Moreover, the pre-charge duration and the time between messages (the values of T4, T1, T2, etc.) may be based on elements of the communication mode. For example, the pre-charge duration may be equal the reciprocal of BLF (1/BLF) and T2 may be equal to twenty times the reciprocal of BLF (20/BLF).

Other factors, such as the duration of a reference interval, may also be selected. As an example, a type A reference interval (“Tari”) may be between six and one-quarter nanoseconds (6.25 μs) and twenty-five nanoseconds (25 μs).

The tag read operation 500 described above may correspond to an RFID protocol (e.g., an RFID air protocol). Ultra-high frequency (UHF) RFID may operate in a sub-GHz bandwidth (860-930 MHz). This bandwidth may be unlicensed spectrum and/or may be associated with regulations that limit transmission power (and thereby limit range). A reader that operates in accordance with RFID protocol may be considered as a remote tag reader (RTR).

UHF RFID has various use cases. For example, in a warehouse inventory and/or stock management scenario, ranges of two meters or more may be utilized. As another example, return and/or checkout services may use a range on the order of five centimeters. Generally, the RFID air protocol may define communication by a single reader (e.g., RFID reader 401) with multiple tags (e.g., passive tags such as RFID tags 421, 422, 423). The reader may extract product serial numbers (e.g., EPC as in the example of tag read operation 500) or may perform read/write operations to the tags.

The reader may include at least one antenna configured to operate at short range (e.g., within the prescribed bandwidth and/or below the maximum transmission power associated with that bandwidth). The reader may be a dedicated RTR. Commercially-available RTRs are often provided in a gun-shaped form factor. Additionally or alternatively, the reader may be a UE with an RTR capability. The RTR capability may be provided by, for example, at least one remote-reading antenna configured to operate at short range, within the prescribed bandwidth, and/or below the maximum transmission power associated with that bandwidth. The RTR capability may also include other functionality related to the at least one remote-reading antenna. The RTR capability may be built into the UE (e.g., the at least one remote-reading antenna may be included in the UE along with one or more WAN antennas, one or more WLAN antennas, one or more Bluetooth antennas, one or more GNSS antennas, or any combination thereof). Additionally or alternatively, the RTR capability may be built into a separate device configured to be attached to the UE.

RTR operations (e.g., such as tag read operation 500 described above) have performance indicators such as range and read rate. Range and read rate may vary based on link quality (e.g., signal-to-noise ratio (SNR), received signal strength indicator (RSSI), etc.), which may be considered as a fundamental metric for reliable communication. Link quality can be improved by modifying transmission power and/or a physical layer configuration (e.g., number of subcarrier cycles per symbol (M), backscatter link frequency (BLF), etc.). The physical layer configuration may be referred to as radio frequency (RF) mode and/or communication mode. The physical layer configuration may be configured by the reader.

RTR operations are highly sensitive to proximity (e.g., due to the reliance on backscatter), and link quality can change quickly in a short amount of time. Moreover, the link quality between the reader and a first tag may vary drastically relative to the link quality between the reader and a second tag. For example, even if two tags are equidistant from the reader, one may be obstructed and the other may be unobstructed.

A communication mode and/or physical layer configuration associated with an RTR operation may be selected (and/or modified) in accordance with aspects of the disclosure, as will be discussed in greater detail below. The selection and/or modification may improve link quality while considering the tradeoffs associated with different communication modes and/or physical layer configurations.

In a scenario where the RTR operation is associated with a UE (e.g., wherein the reader is incorporated to the UE or provided as a UE attachment), UE impact may be considered when selecting and/or modifying the communication mode and/or physical layer configuration. For example, whereas the computational resources of a dedicated RTR may be dedicated entirely to RTR operations, the computational resources of an RTR-capable UE may be divided between RTR operations and other operations. As another example, UEs may be subject to constraints on specific absorption rate (SAR) and power consumption, and for RTR-capable UEs, the impact of RTR operations may be taken into account. Moreover, RTR protocols may have strict timelines (e.g., the amount of time for replying to a tag), and the timeline associated with RTR operations may have to be reconciled with other timelines associated with other UE operations.

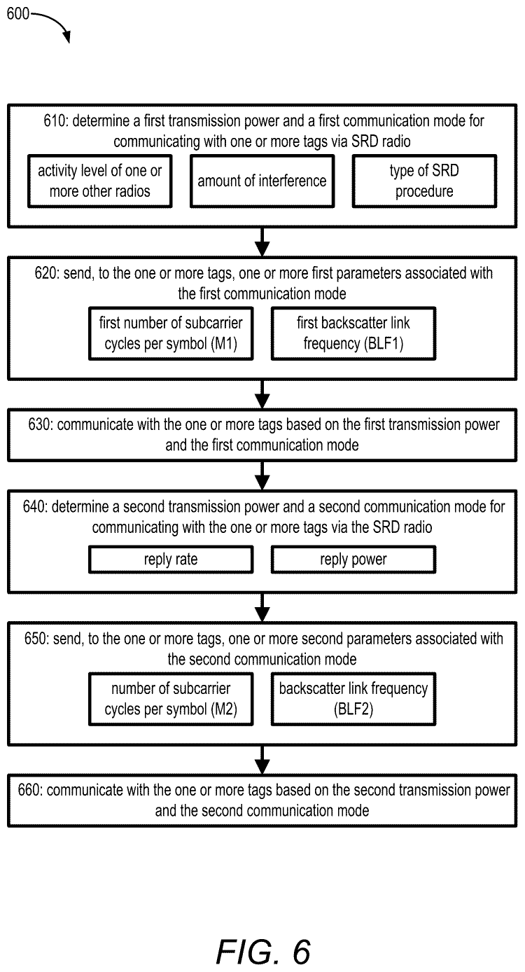

FIG. 6 illustrates a method 600 for selecting and/or modifying a communication mode and/or physical layer configuration associated with one or more RTR operations, in accordance with aspects of the disclosure. The method 600 may be performed by, for example, any of the UEs and/or RTRs described in the present application (e.g., UE 302, RTR 304, RFID reader 401, etc.). The method 600 may involve one or more tags, which may correspond to any of the tags, transponders, remote tags, remote transponders, RFID tags, etc., disclosed herein (e.g., RFID tags 421, 422, 423, etc.). For convenience, the performer of method 600 will be referred to as “the device”.

In method 600, various techniques for selecting and/or modifying a communication mode are disclosed. For example, a parameter may be set or initialized at a specific value (selected) and/or changed to the specific value (modified). It will be understood that if the disclosure provides a particular example of a technique for selecting, then the scope of the disclosure also encompasses an analogous technique for modifying (and vice-versa). For example, if the present disclosure explicitly describes “setting BLF to a low value based on factor X”, it will be understood that “decreasing BLF based on factor X” is implicitly disclosed. If the present disclosure explicitly describes “increasing M based on factor Y”, it will be understood that the disclosure also supports “setting M to a high value based on factor Y”. Etc.

Moreover, terminology such as “high value” and “low value” may be interpreted as being relative to a previous value, a default value, and/or a hypothetical value. For example, if the present disclosure explicitly describes “setting BLF to a low value based on factor X”, it will be understood that the value of BLF is set to: a lower value than a previous value, for example, a decreased value; a lower value than a default value; and/or a lower value than a value that would have been set if not for factor X.

In block 610, the device determines a first transmission power and a first communication mode for communicating with one or more tags (e.g., remote tags, remote transponders, RFID tags, etc.). The communication may be via one or more remote-reading antennas/radios (e.g., the one or more RTR transceivers 350, the one or more RTR transceivers 360, etc.). As will be discussed in greater detail below, the communication mode may be associated with one or more parameters of a physical layer configuration (e.g., number of subcarrier cycles per symbol, backscatter link frequency, etc.).

The determining at 610 may be based on an activity level of one or more other antennas/radios (e.g., other than the one or more remote-reading antennas/radios, such as the one or more WWAN transceivers 310, the one or more remote-reading wireless transceivers 320, the one or more satellite signal interface 330, etc.), an amount of interference, and/or a type of RTR procedure, as will be discussed in greater detail below.

In block 620, the device sends, to the one or more tags, one or more first parameters associated with the first communication mode. The one or more first parameters may include a first number of subcarrier cycles per symbol (M1), a first backscatter link frequency (BLF1), etc. As noted above, for a given transmission power, a higher value for M1 and/or a lower value for BLF1 may result in greater range, more replies, a slower read rate, or any combination thereof. The one or more first parameters may be sent, for example, in a message analogous to the query message 532 described previously.

In a first example related to block 610 and block 620, the device may determine a resource availability level at the device based on the one or more activity levels of the one or more other radios. The resource may be, for example, a power resource (e.g., a battery level) and/or a computational resource (e.g., processing power of one or more processors such as the one or more processors 342, etc.). If the activity level of, for example, a WWAN radio is high, then the power or computational resources available for RTR operations may be limited. By contrast, if the activity level of the WWAN radio is low, then the resources available for RTR operations may be plentiful. During operation of the device, the device may monitor and/or periodically detect concurrency scenarios, for example, concurrent usage of other (e.g., non-RTR) antennas/radios. The device may side-load concurrency information and adjust RTR operations (e.g., range, transmit power, communication mode, etc.) based on the concurrency information.

As a particular example, the device may select a subset of communication modes (e.g., one or more combinations of M, BLF, and/or Tari). The subset of communication modes may be selected such that the device can meet the demand for processing resources while multiple radios (e.g., the RTR radio and the WWAN radio) are concurrently active. The device may select from among the communication modes based on best performance (e.g., fastest read rate, lowest power consumption, etc.) or any other suitable factor.

As a particular implementation, consider a scenario wherein a GNSS radio associated with the device is in a particular operating mode (e.g., an acquisition and/or tracking mode). This particular operating mode may consume substantial computation resources of the device. In such a scenario, availability of computation resources for RTR operations may be low, and the device may have difficulty performing RTR operations with remaining resources. The device may select the one or more first parameters so as to reduce the computational resources needed for RTR operations, thereby enabling the device to perform resource-intensive GNSS operations.

For example, the timings associated with RFID protocols (e.g., T4, T1, T2, etc.) may be dependent on BLF. In particular, T2 may be equal to and/or proportional to twenty divided by BLF (20/BLF). By setting BLF to a low value, the device can space out the tag read sequence and give itself more time between messages to perform RTR-related processing. By setting BLF to the low value, the device can dedicate fewer computational resources to RTR operations while successfully completing computation-intensive operations associated with (for example) the GNSS tracking and/or acquisition mode. By contrast, if the GNSS radio is in a power-optimized and/or intermediate-power mode, or a non-operating mode, the device can dedicate increasingly more computational resources to RTR operations. With activity levels of the GNSS radio being lower, computational resources become more available for RTR procedures, and the device may achieve higher performance in RTR-related operations. For example, with greater resource availability, the device can set BLF to a higher value and achieve a higher read rate.

Additionally or alternatively, the device may modify M to accommodate scarcity of resources (by setting M to a high value) or to achieve a higher read rate (by setting M to a low value). Additionally or alternatively, the device may modify a Tari value. For example, by increasing a Tari value, the device can space out the tag read sequence and relieve itself of computational burden.

In a second example related to block 610 and block 620, the device may determine a resource availability level at the device based on the communication mode the type of RTR procedure. Types of RTR procedure may include an inventory procedure, an access procedure, or a write procedure. In an example, the device may determine to increase M, thereby increasing the success rate of the RTR operation, based on the procedure being an access/write procedure.

In a third example related to block 610 and block 620, the device may determine a specific absorption rate (SAR) exposure level based on the one or more activity levels of the one or more radios. SAR may be a measure of the rate of radio frequency energy absorption by a human body from the source being measured (e.g., transmission by the device). One or more regulatory agencies may proscribe SAR exposure above a certain level. Additionally or alternatively, manufacturers may set limits on SAR exposure. Accordingly, if the device has multiple antennas/radios, the device may calculate the sum of SAR exposures caused by each antenna/radio.

If the SAR exposure level associated with the device (e.g., the sum of the SAR exposure levels caused by each antenna/radio in the device) is at or near a limit (e.g., above a SAR exposure level threshold, or within a particular distance from a maximum SAR exposure level), then the device may select a communication mode for the one or more remote-reading antennas/radios of the device that reduces the RTR-related contribution to SAR exposure. To reduce the RTR-related contribution to SAR exposure, the device may select a low transmission power for RTR-related transmissions (e.g., the continuous wave 520), select a high value for BLF, and/or select a low value for M (e.g., to shorten an RTR procedure so that transmission of continuous wave 520 stops earlier).

In a fourth example related to block 610 and block 620, the device may determine a self-interference level associated with an RTR procedure. For example, the device may transmit a continuous wave (e.g., continuous wave 520) during an RTR procedure. The continuous wave may be transmitted via one or more remote-reading antennas/radios. The continuous wave transmission may interfere with one or more other antennas/radios associated with the device. As an example, consider a scenario where the device is using the one or more remote-reading antennas/radios to perform an RTR procedure and using a Wi-Fi transceiver (e.g., the one or more remote-reading wireless transceivers 320) to communicate via Wi-Fi. The continuous wave transmitted during the RTR procedure may interfere with the transmission and/or reception of Wi-Fi signaling.

The device may monitor self-interference. For example, if the link quality associated with one or more other antennas/radios is low, then the device may determine that an RTR operation is causing self-interference. Additionally or alternatively, if the link quality associated with one or more other antennas/radios abruptly decreases, then the device may determine that an RTR operation is causing self-interference. Additionally or alternatively, if the link quality associated with one or more other antennas/radios abruptly decreases at the same time that an RTR operation begins, then the device may determine that an RTR operation is causing self-interference.

The device may predict and/or estimate that the RTR operation will cause self-interference. For example, if the device determines that the one or more remote-reading antennas/radios and the one or more other antennas/radios will be used concurrently, then the device may determine that an RTR operation is likely to cause self-interference. Additionally or alternatively, if the device determines that the one or more remote-reading antennas/radios and the one or more other antennas/radios will use the same bandwidth and/or frequencies, then the device may determine that an RTR operation is likely to cause self-interference.

If self-interference with the one or more other antennas/radios is detected or predicted, the device may decrease transmission power of RTR-related transmissions (e.g., the continuous wave 520), decrease M, and/or increase BLF (e.g., to shorten an RTR procedure so that transmission of continuous wave 520 stops earlier).

The device may monitor and/or listen for interference prior to an RTR operation and/or during an RTR message sequence (e.g., periodically, between messages, during T1, during T2, or any combination thereof).

In a fifth example related to block 610 and block 620, the device may determine an interference level caused by noise, a radio jammer, another RTR device (e.g., another device similar to RFID reader 401) or any combination thereof. For example, the device may monitor and/or listen for noise/jamming prior to an RTR operation and/or during an RTR message sequence (e.g., periodically, between messages, during T1, during T2, or any combination thereof). If noise/jamming exceeds a threshold amount and/or continues for a threshold amount of time, then the device may increase transmission power of RTR-related transmissions (e.g., the continuous wave 520), decrease M, and/or increase BLF.

If a jammer is detected, or self-interference or interference from another reader causes saturation, then the device may detect the interference during T1 and/or T2, or during any other time instance when a downlink signal is not received. At a next time instance, the device can update the a received gain state and/or transmit power. The communication mode (e.g., M and/or BLF) may be modified to work with an updated noise figure.

In block 630, the device communicates with the one or more tags based on the first transmission power and the first communication mode (i.e., M1 and/or BLF1). For example, the continuous wave 520, select message 531, query message 532, etc., may be transmitted by the device with the first transmission power determined at 610. The messages received from the respective tags (e.g., random number message 541, EPC message 543, etc.) may be received in accordance with M1 and/or BLF1, as determined at 610.

In block 640, the device determines a second transmission power and a second communication mode for communicating with the one or more tags. The communication may be via one or more remote-reading antennas/radios.

The determining at 640 may be based on any of the factors associated with the determining at 610 (e.g., activity level of one or more other antennas/radios, amount of interference, and/or type of RTR procedure). Additionally or alternatively, the determining at 640 may be based on factors associated with the communicating at 630. For example, the communicating at 630, which is based on the first transmission power and the first communication mode (associated with M1 and/or BLF1), may result in a particular reply rate and/or reply power. Based on the reply rate and/or reply power, the device may modify the first transmission power (increase or decrease) and/or modify the first communication mode (changing M1 to M2 and/or BLF1 to BLF2).

Reply rate may correspond to a number of replies received from the one or more tags divided by a number of replies expected from the one or more tags. The number of replies expected may be equal to a size of the tag population. If a reply rate of the one or more tags involved in the communicating at 630 is low (e.g., below a reply rate threshold and/or minimum reply rate), then the device may increase the transmission power (e.g., to increase the range in the forward link), increase M (e.g., M2>M1, to make the replies of the one or more tags less susceptible to noise and interference), and/or decrease BLF (e.g., BLF2<BLF1, to increase the range in the reverse link). If the reply rate of the one or more tags involved in the communicating at 630 is high, this may imply a dense population of tags. If the reply rate of the one or more tags involved in the communicating at 630 is high (e.g., above a reply rate threshold and/or maximum reply rate), then the device may decrease the transmission power (e.g., to consume less power), decrease M (e.g., M2<M1, to speed up the read rate), and/or increase BLF (e.g., BLF2>BLF1, to speed up the read rate).

Reply power may correspond to a received signal strength indicator (RSSI), a signal-to-noise rate (SNR), or any combination thereof, of one or more replies received from the one or more tags. If a reply power of the one or more tags involved in the communicating at 630 is low (e.g., below an SNR threshold and/or minimum SNR), then the device may increase the transmission power (e.g., to increase the power available for backscatter), increase M (e.g., M2>M1, to improve reliability in spite of low SNR), and/or decrease BLF (e.g., BLF2<BLF1, to increase the range in the reverse link). If the reply power of the one or more tags involved in the communicating at 630 is high (e.g., above an SNR threshold and/or maximum SNR), then the device may decrease the transmission power (e.g., to consume less power), decrease M (e.g., M2<M1, to speed up the read rate), and/or increase BLF (e.g., BLF2>BLF1, to speed up the read rate).

Based on transmission power, the device may select M and/or BLF so as to balance a range between forward link and reverse link. For example, if reply power (e.g., RSSI/SNR) from tag replies is lower than expected most of time, the device may switch to a higher value of M. Low reply power may be caused by, for example, obstacle blocking, antenna orientation mismatch, degraded self-transmission leakage performance, de-sensing due to other active radios, etc.

In an example, if the device observes a high tag reply rate for a give value of M (e.g., a number of tags found in in a particular number of seconds, milliseconds, etc.), then the device may switch to a more power-efficient mode of operation. To become more power efficient, the device may reduce transmission power and/or M value to find nearby tags at a higher read rate. Once nearby tags are read (e.g., additional tags are not detected), the device may increase transmission power and/or M value in a step-wise manner.

In block 650, the device sends, to the one or more tags, one or more second parameters associated with the second communication mode. The one or more second parameters may include a second number of subcarrier cycles per symbol (M2), a second backscatter link frequency (BLF2), etc. For example, in block 620, the device may send parameter M1 to the one or more tags. In block 630, the device may communicate with one or more tags based on M1; the reply power may be below an SNR threshold. As a result, in block 640, the device may determine to increase the number of subcarrier cycles per symbol from M1 to M2. In block 650, the device may send the parameter M2 to the one or more tags.

The sending at 650 may be performed in such a manner as to avoid unnecessary interruption to an RTR operation. For example, an initial parameter (e.g., M1 and/or BLF1) may be sent in a round-specific or session-specific message (e.g., query message 532). An updated parameter (e.g., M2 and/or BLF2) may be sent after a particular tag-specific messaging sequence is complete and/or before the next tag-specific messaging sequence begins.

In the context of an inventory sequence (e.g., as in FIG. 5), the initial parameter may be sent in query message 532. To send the updated parameter, the device may send a second query message (analogous to query message 532, but with different timing and/or position within the messaging sequence). For example, the second query message may be sent after EPC message 543 is received (in the first tag read sequence 501), after EPC message 553 is received (in the first subsequent tag read sequence 511), or after some later EPC message is received (e.g., in a second subsequent tag read sequence, third subsequent tag read sequence, etc.). Additionally or alternatively, the second query message may be sent before query repeat message 544 is transmitted, before query repeat message 554 is transmitted, or after some later query repeat message is transmitted. Additionally or alternatively, the updated parameter may be sent in the query repeat message 544, in the query repeat message 554, or in some later query repeat message. Additionally or alternatively, the updated parameter may be sent in a generic and/or differently-named message that is sent after an EPC message is received from a particular tag, and that comprises the updated parameter, one or more elements of a query message, and/or one or more elements of a query repeat message.

In the context of an access sequence (e.g., a read and/or write operation), the updated parameter may be after access to a particular tag is complete and/or before access to the next tag begins. After access for a particular tag is complete, the access procedure may be terminated and restarted. The restarting of the access procedure may comprise, for example, sending of a query message comprising the updated parameter.

In block 660, the device communicates with the one or more tags based on the second transmission power and the second communication mode (i.e., M2 and/or BLF2). For example, the continuous wave 520, select message 531, query message 532, etc., may be transmitted by the device with the first transmission power determined at 640. The messages received from the respective tags (e.g., random number message 541, EPC message 543, etc.) may be received in accordance with M2 and/or BLF2, as determined at 640.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

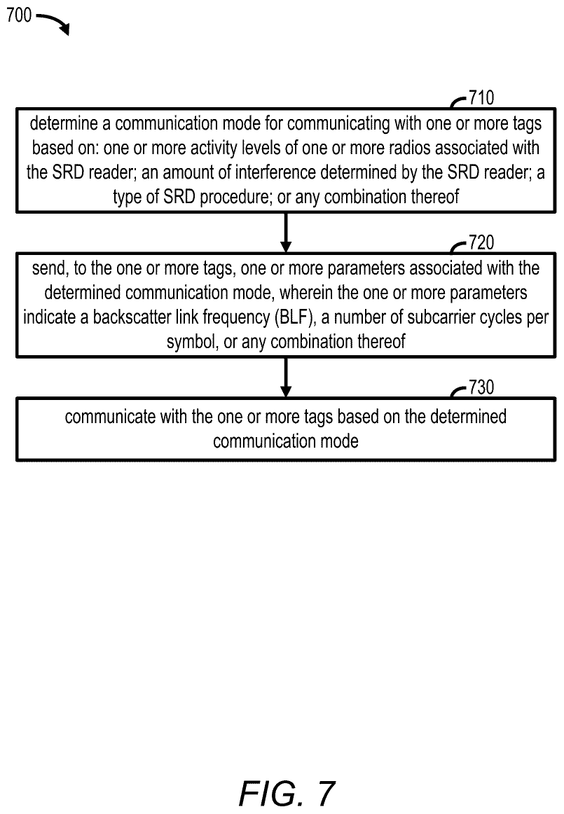

FIG. 7 illustrates an example method 700 of wireless communication, according to aspects of the disclosure. In an aspect, method 700 may be performed by an RTR (e.g., the UE 302, the RTR 304, the RFID reader 401, or any of the UEs/RTRs/readers described herein).

At 710, the RTR determines a communication mode for communicating with one or more remote tags based on: one or more activity levels of one or more radios associated with the RTR reader; an amount of interference determined by the RTR reader; a type of RTR procedure; or any combination thereof.

In an aspect, where the RTR is a UE (e.g., analogous to UE 302), operation 710 may be performed by the memory 340, the one or more processors 342, and/or the reading component 348, any or all of which may be considered means for performing this operation. In an aspect, where the RTR is a dedicated RTR and/or reader (e.g., analogous to RTR 304), operation 710 may be performed by the one or more WWAN transceivers 350, the one or more remote-reading wireless transceivers 360, the memory 386, the one or more processors 384, and/or the reading component 388, any or all of which may be considered means for performing this operation.

At 720, the RTR sends, to the one or more remote tags, one or more parameters associated with the determined communication mode, wherein the one or more parameters indicate a backscatter link frequency (BLF), a number of subcarrier cycles per symbol, or any combination thereof.

In an aspect, where the RTR is a UE (e.g., analogous to UE 302), operation 720 may be performed by the one or more RTR transceivers 350, the memory 340, the one or more processors 342, and/or the reading component 348, any or all of which may be considered means for performing this operation. In an aspect, where the RTR is a dedicated RTR and/or reader (e.g., analogous to RTR 304), operation 720 may be performed by the one or more RTR transceivers 360, the memory 386, the one or more processors 384, and/or the reading component 388, any or all of which may be considered means for performing this operation.

At 730, the RTR communicates with the one or more remote tags based on the determined communication mode.

In an aspect, where the RTR is a UE (e.g., analogous to UE 302), operation 730 may be performed by the one or more RTR transceivers 350, the memory 340, the one or more processors 342, and/or the reading component 348, any or all of which may be considered means for performing this operation. In an aspect, where the RTR is a dedicated RTR and/or reader (e.g., analogous to RTR 304), operation 730 may be performed by the one or more RTR transceivers 360, the memory 386, the one or more processors 384, and/or the reading component 388, any or all of which may be considered means for performing this operation.

As will be appreciated, a technical advantage of the method 700 is that by determining the communication mode based on the factors described above, the described techniques can be used to balance tradeoffs between resource consumption by the RTR and performance of an RTR operation. For example, in accordance with aspects of the disclosure, better performance (e.g., faster read rate, higher tag detection ratio) may be increased by setting and/or modifying the one or more parameters. Additionally or alternatively, by determining the communication mode based on the factors described above, the described techniques can be used to improve the efficiency of a device (e.g., a user equipment (UE)) that includes one or more remote-reading antennas/radios and one or more other antennas/radios (e.g., WWAN, WLAN, Bluetooth, etc.). For example, in accordance with aspects of the disclosure, the device can select and/or modify the one or more parameters so as to allocate power resources and/or computational resources to an RTR operation in a manner that does not limit non-RTR operations of the device. For example, in accordance with aspects of the disclosure, the device can select and/or modify the one or more parameters so as to prevent interference with the one or more other antennas/radios of the device.

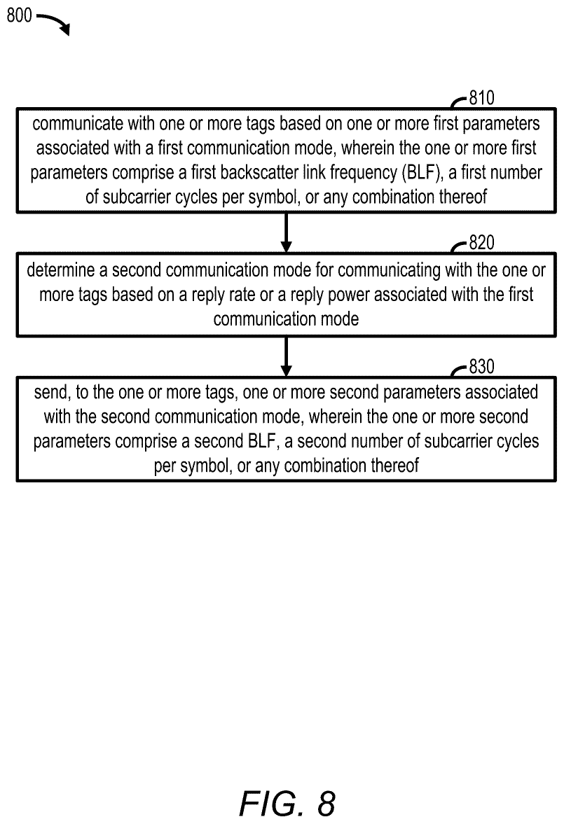

FIG. 8 illustrates an example method 800 of wireless communication, according to aspects of the disclosure. In an aspect, method 800 may be performed by an RTR (e.g., the UE 302, the RTR 304, the RFID reader 401, or any of the UEs/RTRs/readers described herein).

At 810, the RTR communicates with one or more remote tags based on one or more first parameters associated with a first communication mode, wherein the one or more first parameters comprise a first backscatter link frequency (BLF), a first number of subcarrier cycles per symbol, or any combination thereof.

In an aspect, where the RTR is a UE (e.g., analogous to UE 302), operation 810 may be performed by the one or more RTR transceivers 350, the memory 340, the one or more processors 342, and/or the reading component 348, any or all of which may be considered means for performing this operation. In an aspect, where the RTR is a dedicated RTR and/or reader (e.g., analogous to RTR 304), operation 810 may be performed by the one or more RTR transceivers 360, the memory 386, the one or more processors 384, and/or the reading component 388, any or all of which may be considered means for performing this operation.

At 820, the RTR determines a second communication mode for communicating with the one or more remote tags based on a reply rate or a reply power associated with the first communication mode.

In an aspect, where the RTR is a UE (e.g., analogous to UE 302), operation 820 may be performed by the memory 340, the one or more processors 342, and/or the reading component 348, any or all of which may be considered means for performing this operation. In an aspect, where the RTR is a dedicated RTR and/or reader (e.g., analogous to RTR 304), operation 820 may be performed by the memory 386, the one or more processors 384, and/or the reading component 388, any or all of which may be considered means for performing this operation.

At 830, the RTR sends, to the one or more remote tags, one or more second parameters associated with the second communication mode, wherein the one or more second parameters comprise a second BLF, a second number of subcarrier cycles per symbol, or any combination thereof.

In an aspect, where the RTR is a UE (e.g., analogous to UE 302), operation 830 may be performed by the one or more RTR transceivers 350, the memory 340, the one or more processors 342, and/or the reading component 348, any or all of which may be considered means for performing this operation. In an aspect, where the RTR is a dedicated RTR and/or reader (e.g., analogous to RTR 304), operation 830 may be performed by the one or more RTR transceivers 360, the memory 386, the one or more processors 384, and/or the reading component 388, any or all of which may be considered means for performing this operation.

As will be appreciated, a technical advantage of the method 800 is that by determining the second communication mode based on reply rate and/or reply power (and sending the one or more second parameters to the one or more tags), the described techniques can be used to increase performance of an RTR operation (e.g., modify the communication mode so as to increase the reply rate and/or reply power), or by increasing the efficiency of the device (e.g., modify the communication mode so as to decrease power consumption).

Implementation examples are described in the following numbered clauses:

Clause 1. A method of wireless communication performed by a remote tag reader (RTR), comprising: determining a communication mode for communicating with one or more remote tags based on: one or more activity levels of one or more radios associated with the RTR; an amount of interference determined by the RTR; a type of RTR procedure; or any combination thereof; sending, to the one or more tags, one or more parameters associated with the determined communication mode, wherein the one or more parameters indicate a backscatter link frequency (BLF), a number of subcarrier cycles per symbol, or any combination thereof; and communicating with the one or more tags based on the determined communication mode.

Clause 2. The method of clause 1, wherein: the RTR is a user equipment (UE) that comprises an RTR radio and the one or more radios; the communicating with the one or more tags is via the RTR radio; and the one or more radios comprise a wireless wide area network (WWAN) radio, a wireless local area network (WLAN) radio, a Bluetooth radio, a global navigation satellite system (GNSS) radio, or any combination thereof.

Clause 3. The method of any of clauses 1 to 2, further comprising: determining a resource availability level at the RTR based on the one or more activity levels of the one or more radios; selecting the one or more parameters based on the resource availability level, wherein the selecting comprises: selecting a first BLF or a first number of subcarrier cycles per symbol, based on determining a first resource availability level; or selecting a second BLF that is lower than the first BLF, a second number of subcarrier cycles per symbol that is higher than the first number of subcarrier cycles per symbol, or any combination thereof, based on determining a second resource availability that is lower than the first resource availability level.

Clause 4. The method of clause 3, wherein the one or more activity levels comprise: one or more first activity levels corresponding to an acquisition mode of a GNSS radio, a tracking mode of the GNSS radio, and a power-optimized mode of the GNSS radio; and a second activity level corresponding to a non-operating mode of the GNSS radio.

Clause 5. The method of any of clauses 3 to 4, wherein the one or more activity levels comprise: one or more first activity levels corresponding to one or more operating modes of a radio of the one or more radios; and a second activity level corresponding to a non-operating mode of the radio.

Clause 6. The method of any of clauses 1 to 5, further comprising determining the communication mode for communicating with the one or more tags based on the type of RTR procedure, wherein the type of RTR procedure comprises an inventory procedure, an access procedure, or a write procedure.

Clause 7. The method of any of clauses 1 to 6, further comprising: determining a specific absorption rate (SAR) exposure level based on the one or more activity levels of the one or more radios; selecting the one or more parameters based on the SAR exposure level, wherein the selecting comprises: selecting a first BLF or a first number of subcarrier cycles per symbol, based on determining a first SAR exposure level; or selecting a second BLF that is higher than the first BLF, a second number of subcarrier cycles per symbol that is lower than the first number of subcarrier cycles per symbol, or any combination thereof, based on determining a second SAR exposure level that is higher than the first SAR exposure level.

Clause 8. The method of any of clauses 1 to 7, further comprising: determining a self-interference level caused by a continuous wave (CW) transmission of an RTR radio of the RTR; selecting the one or more parameters based on the self-interference level, wherein the selecting comprises: selecting a first BLF or a first number of subcarrier cycles per symbol, based on determining a first self-interference level; or selecting a second BLF that is lower than the first BLF, a second number of subcarrier cycles per symbol that is higher than the first number of subcarrier cycles per symbol, or any combination thereof, based on determining a second self-interference level that is higher than the first self-interference level.

Clause 9. The method of any of clauses 1 to 8, further comprising: determining an interference level caused by noise, a radio jammer, or any combination thereof; selecting the one or more parameters based on the interference level, wherein the selecting comprises: selecting a first BLF or a first number of subcarrier cycles per symbol, based on determining a first interference level; or selecting a second BLF that is lower than the first BLF, a second number of subcarrier cycles per symbol that is higher than the first number of subcarrier cycles per symbol, or any combination thereof, based on determining a second interference level that is higher than the first interference level.

Clause 10. The method of clause 9, further comprising: monitoring, during a first time duration T1 following a RTR transmission or a second time duration T2 following a RTR reception, one or more frequencies.

Clause 11. The method of any of clauses 1 to 10, wherein the one or more parameters are sent to the one or more tags in a query command.

Clause 12. A remote tag reader (RTR) comprising: one or more memories; one or more transceivers; and one or more processors communicatively coupled to the one or more memories and the one or more transceivers, the one or more processors, either alone or in combination, configured to: determine a communication mode for communicating with one or more remote tags based on: one or more activity levels of one or more radios associated with the RTR; an amount of interference determined by the RTR; a type of RTR procedure; or any combination thereof; send, via the one or more transceivers, to the one or more tags, one or more parameters associated with the determined communication mode, wherein the one or more parameters indicate a backscatter link frequency (BLF), a number of subcarrier cycles per symbol, or any combination thereof; and communicate with the one or more tags based on the determined communication mode.

Clause 13. The RTR of clause 12, wherein: the RTR is a user equipment (UE) that comprises an RTR radio and the one or more radios; the communicating with the one or more tags is via the RTR radio; and the one or more radios comprise a wireless wide area network (WWAN) radio, a wireless local area network (WLAN) radio, a Bluetooth radio, a global navigation satellite system (GNSS) radio, or any combination thereof.

Clause 14. The RTR of any of clauses 12 to 13, wherein the one or more processors, either alone or in combination, are further configured to: determine a resource availability level at the RTR based on the one or more activity levels of the one or more radios; select the one or more parameters based on the resource availability level, wherein the selecting comprises: select a first BLF or a first number of subcarrier cycles per symbol, based on determining a first resource availability level; or select a second BLF that is lower than the first BLF, a second number of subcarrier cycles per symbol that is higher than the first number of subcarrier cycles per symbol, or any combination thereof, based on determining a second resource availability that is lower than the first resource availability level.

Clause 15. The RTR of clause 14, wherein the one or more activity levels comprise: one or more first activity levels corresponding to an acquisition mode of a GNSS radio, a tracking mode of the GNSS radio, and a power-optimized mode of the GNSS radio; and a second activity level corresponding to a non-operating mode of the GNSS radio.

Clause 16. The RTR of any of clauses 14 to 15, wherein the one or more activity levels comprise: one or more first activity levels corresponding to one or more operating modes of a radio of the one or more radios; and a second activity level corresponding to a non-operating mode of the radio.

Clause 17. The RTR of any of clauses 12 to 16, wherein the one or more processors, either alone or in combination, are further configured to determine the communication mode for communicating with the one or more tags based on the type of RTR procedure, wherein the type of RTR procedure comprises an inventory procedure, an access procedure, or a write procedure.

Clause 18. The RTR of any of clauses 12 to 17, wherein the one or more processors, either alone or in combination, are further configured to: determine a specific absorption rate (SAR) exposure level based on the one or more activity levels of the one or more radios; select the one or more parameters based on the SAR exposure level, wherein the selecting comprises: select a first BLF or a first number of subcarrier cycles per symbol, based on determining a first SAR exposure level; or select a second BLF that is higher than the first BLF, a second number of subcarrier cycles per symbol that is lower than the first number of subcarrier cycles per symbol, or any combination thereof, based on determining a second SAR exposure level that is higher than the first SAR exposure level.

Clause 19. The RTR of any of clauses 12 to 18, wherein the one or more processors, either alone or in combination, are further configured to: determine a self-interference level caused by a continuous wave (CW) transmission of an RTR radio of the RTR; select the one or more parameters based on the self-interference level, wherein the selecting comprises: select a first BLF or a first number of subcarrier cycles per symbol, based on determining a first self-interference level; or select a second BLF that is lower than the first BLF, a second number of subcarrier cycles per symbol that is higher than the first number of subcarrier cycles per symbol, or any combination thereof, based on determining a second self-interference level that is higher than the first self-interference level.

Clause 20. The RTR of any of clauses 12 to 19, wherein the one or more processors, either alone or in combination, are further configured to: determine an interference level caused by noise, a radio jammer, or any combination thereof; select the one or more parameters based on the interference level, wherein the selecting comprises: select a first BLF or a first number of subcarrier cycles per symbol, based on determining a first interference level; or select a second BLF that is lower than the first BLF, a second number of subcarrier cycles per symbol that is higher than the first number of subcarrier cycles per symbol, or any combination thereof, based on determining a second interference level that is higher than the first interference level.

Clause 21. The RTR of clause 20, wherein the one or more processors, either alone or in combination, are further configured to: monitor, during a first time duration T1 following a RTR transmission or a second time duration T2 following a RTR reception, one or more frequencies.

Clause 22. The RTR of any of clauses 12 to 21, wherein the one or more parameters are sent to the one or more tags in a query command.

Clause 23. A remote tag reader (RTR) comprising: means for determining a communication mode for communicating with one or more remote tags based on: one or more activity levels of one or more radios associated with the RTR; an amount of interference determined by the RTR; a type of RTR procedure; or any combination thereof; means for sending, to the one or more tags, one or more parameters associated with the determined communication mode, wherein the one or more parameters indicate a backscatter link frequency (BLF), a number of subcarrier cycles per symbol, or any combination thereof; and means for communicating with the one or more tags based on the determined communication mode.

Clause 24. The RTR of clause 23, wherein: the RTR is a user equipment (UE) that comprises an RTR radio and the one or more radios; the communicating with the one or more tags is via the RTR radio; and the one or more radios comprise a wireless wide area network (WWAN) radio, a wireless local area network (WLAN) radio, a Bluetooth radio, a global navigation satellite system (GNSS) radio, or any combination thereof.

Clause 25. The RTR of any of clauses 23 to 24, further comprising: means for determining a resource availability level at the RTR based on the one or more activity levels of the one or more radios; means for selecting the one or more parameters based on the resource availability level, wherein the selecting comprises: means for selecting a first BLF or a first number of subcarrier cycles per symbol, based on determining a first resource availability level; or means for selecting a second BLF that is lower than the first BLF, a second number of subcarrier cycles per symbol that is higher than the first number of subcarrier cycles per symbol, or any combination thereof, based on determining a second resource availability that is lower than the first resource availability level.

Clause 26. The RTR of clause 25, wherein the one or more activity levels comprise: one or more first activity levels corresponding to an acquisition mode of a GNSS radio, a tracking mode of the GNSS radio, and a power-optimized mode of the GNSS radio; and a second activity level corresponding to a non-operating mode of the GNSS radio.

Clause 27. The RTR of any of clauses 25 to 26, wherein the one or more activity levels comprise: one or more first activity levels corresponding to one or more operating modes of a radio of the one or more radios; and a second activity level corresponding to a non-operating mode of the radio.

Clause 28. The RTR of any of clauses 23 to 27, further comprising means for determining the communication mode for communicating with the one or more tags based on the type of RTR procedure, wherein the type of RTR procedure comprises an inventory procedure, an access procedure, or a write procedure.

Clause 29. The RTR of any of clauses 23 to 28, further comprising: means for determining a specific absorption rate (SAR) exposure level based on the one or more activity levels of the one or more radios; means for selecting the one or more parameters based on the SAR exposure level, wherein the selecting comprises: means for selecting a first BLF or a first number of subcarrier cycles per symbol, based on determining a first SAR exposure level; or means for selecting a second BLF that is higher than the first BLF, a second number of subcarrier cycles per symbol that is lower than the first number of subcarrier cycles per symbol, or any combination thereof, based on determining a second SAR exposure level that is higher than the first SAR exposure level.

Clause 30. The RTR of any of clauses 23 to 29, further comprising: means for determining a self-interference level caused by a continuous wave (CW) transmission of an RTR radio of the RTR; means for selecting the one or more parameters based on the self-interference level, wherein the selecting comprises: means for selecting a first BLF or a first number of subcarrier cycles per symbol, based on determining a first self-interference level; or means for selecting a second BLF that is lower than the first BLF, a second number of subcarrier cycles per symbol that is higher than the first number of subcarrier cycles per symbol, or any combination thereof, based on determining a second self-interference level that is higher than the first self-interference level.

Clause 31. The RTR of any of clauses 23 to 30, further comprising: means for determining an interference level caused by noise, a radio jammer, or any combination thereof; means for selecting the one or more parameters based on the interference level, wherein the selecting comprises: means for selecting a first BLF or a first number of subcarrier cycles per symbol, based on determining a first interference level; or means for selecting a second BLF that is lower than the first BLF, a second number of subcarrier cycles per symbol that is higher than the first number of subcarrier cycles per symbol, or any combination thereof, based on determining a second interference level that is higher than the first interference level.

Clause 32. The RTR of clause 31, further comprising: means for monitoring, during a first time duration T1 following a RTR transmission or a second time duration T2 following a RTR reception, one or more frequencies.

Clause 33. The RTR of any of clauses 23 to 32, wherein the one or more parameters are sent to the one or more tags in a query command.

Clause 34. A non-transitory computer-readable medium storing computer-executable instructions that, when executed by a remote tag reader (RTR), cause the RTR to: determine a communication mode for communicating with one or more remote tags based on: one or more activity levels of one or more radios associated with the RTR; an amount of interference determined by the RTR; a type of RTR procedure; or any combination thereof; send, to the one or more tags, one or more parameters associated with the determined communication mode, wherein the one or more parameters indicate a backscatter link frequency (BLF), a number of subcarrier cycles per symbol, or any combination thereof; and communicate with the one or more tags based on the determined communication mode.

Clause 35. The non-transitory computer-readable medium of clause 34, wherein: the RTR is a user equipment (UE) that comprises an RTR radio and the one or more radios; the communicating with the one or more tags is via the RTR radio; and the one or more radios comprise a wireless wide area network (WWAN) radio, a wireless local area network (WLAN) radio, a Bluetooth radio, a global navigation satellite system (GNSS) radio, or any combination thereof.

Clause 36. The non-transitory computer-readable medium of any of clauses 34 to 35, further comprising computer-executable instructions that, when executed by the RTR, cause the RTR to: determine a resource availability level at the RTR based on the one or more activity levels of the one or more radios; select the one or more parameters based on the resource availability level, wherein the selecting comprises: select a first BLF or a first number of subcarrier cycles per symbol, based on determining a first resource availability level; or select a second BLF that is lower than the first BLF, a second number of subcarrier cycles per symbol that is higher than the first number of subcarrier cycles per symbol, or any combination thereof, based on determining a second resource availability that is lower than the first resource availability level.

Clause 37. The non-transitory computer-readable medium of clause 36, wherein the one or more activity levels comprise: one or more first activity levels corresponding to an acquisition mode of a GNSS radio, a tracking mode of the GNSS radio, and a power-optimized mode of the GNSS radio; and a second activity level corresponding to a non-operating mode of the GNSS radio.

Clause 38. The non-transitory computer-readable medium of any of clauses 36 to 37, wherein the one or more activity levels comprise: one or more first activity levels corresponding to one or more operating modes of a radio of the one or more radios; and a second activity level corresponding to a non-operating mode of the radio.

Clause 39. The non-transitory computer-readable medium of any of clauses 34 to 38, further comprising computer-executable instructions that, when executed by the RTR, cause the RTR to determine the communication mode for communicating with the one or more tags based on the type of RTR procedure, wherein the type of RTR procedure comprises an inventory procedure, an access procedure, or a write procedure.

Clause 40. The non-transitory computer-readable medium of any of clauses 34 to 39, further comprising computer-executable instructions that, when executed by the RTR, cause the RTR to: determine a specific absorption rate (SAR) exposure level based on the one or more activity levels of the one or more radios; select the one or more parameters based on the SAR exposure level, wherein the selecting comprises: select a first BLF or a first number of subcarrier cycles per symbol, based on determining a first SAR exposure level; or select a second BLF that is higher than the first BLF, a second number of subcarrier cycles per symbol that is lower than the first number of subcarrier cycles per symbol, or any combination thereof, based on determining a second SAR exposure level that is higher than the first SAR exposure level.

Clause 41. The non-transitory computer-readable medium of any of clauses 34 to 40, further comprising computer-executable instructions that, when executed by the RTR, cause the RTR to: determine a self-interference level caused by a continuous wave (CW) transmission of an RTR radio of the RTR; select the one or more parameters based on the self-interference level, wherein the selecting comprises: select a first BLF or a first number of subcarrier cycles per symbol, based on determining a first self-interference level; or select a second BLF that is lower than the first BLF, a second number of subcarrier cycles per symbol that is higher than the first number of subcarrier cycles per symbol, or any combination thereof, based on determining a second self-interference level that is higher than the first self-interference level.

Clause 42. The non-transitory computer-readable medium of any of clauses 34 to 41, further comprising computer-executable instructions that, when executed by the RTR, cause the RTR to: determine an interference level caused by noise, a radio jammer, or any combination thereof; select the one or more parameters based on the interference level, wherein the selecting comprises: select a first BLF or a first number of subcarrier cycles per symbol, based on determining a first interference level; or select a second BLF that is lower than the first BLF, a second number of subcarrier cycles per symbol that is higher than the first number of subcarrier cycles per symbol, or any combination thereof, based on determining a second interference level that is higher than the first interference level.

Clause 43. The non-transitory computer-readable medium of clause 42, further comprising computer-executable instructions that, when executed by the RTR, cause the RTR to: monitor, during a first time duration T1 following a RTR transmission or a second time duration T2 following a RTR reception, one or more frequencies.

Clause 44. The non-transitory computer-readable medium of any of clauses 34 to 43, wherein the one or more parameters are sent to the one or more tags in a query command.

Clause 45. A method of wireless communication performed by a remote tag reader (RTR), comprising: communicating with one or more tags based on one or more first parameters associated with a first communication mode, wherein the one or more first parameters comprise a first backscatter link frequency (BLF), a first number of subcarrier cycles per symbol, or any combination thereof; determining a second communication mode for communicating with the one or more tags based on a reply rate or a reply power associated with the first communication mode; and sending, to the one or more tags, one or more second parameters associated with the second communication mode, wherein the one or more second parameters comprise a second BLF, a second number of subcarrier cycles per symbol, or any combination thereof.

Clause 46. The method of clause 45, wherein: the reply rate corresponds to a number of replies received from the one or more tags divided by a number of replies expected from the one or more tags; and the reply power corresponds to a received signal strength indicator (RSSI), a signal-to-noise rate (SNR), or any combination thereof, of one or more replies received from the one or more tags.

Clause 47. The method of any of clauses 45 to 46, wherein based on the reply rate being below a first reply rate threshold, the reply power being below a first reply power threshold, or any combination thereof: the second BLF is lower than the first BLF; the second number of subcarrier cycles per symbol is higher than the first number of subcarrier cycles per symbol; or any combination thereof.

Clause 48. The method of any of clauses 45 to 47, wherein based on the reply rate being above a second reply rate threshold, the reply power being above a second reply power threshold, or any combination thereof: the second BLF is higher than the first BLF; the second number of subcarrier cycles per symbol is lower than the first number of subcarrier cycles per symbol; or any combination thereof.

Clause 49. A remote tag reader (RTR) comprising: one or more memories; one or more transceivers; and one or more processors communicatively coupled to the one or more memories and the one or more transceivers, the one or more processors, either alone or in combination, configured to: communicate with one or more tags based on one or more first parameters associated with a first communication mode, wherein the one or more first parameters comprise a first backscatter link frequency (BLF), a first number of subcarrier cycles per symbol, or any combination thereof; determine a second communication mode for communicating with the one or more tags based on a reply rate or a reply power associated with the first communication mode; and send, via the one or more transceivers, to the one or more tags, one or more second parameters associated with the second communication mode, wherein the one or more second parameters comprise a second BLF, a second number of subcarrier cycles per symbol, or any combination thereof.

Clause 50. The RTR of clause 49, wherein: the reply rate corresponds to a number of replies received from the one or more tags divided by a number of replies expected from the one or more tags; and the reply power corresponds to a received signal strength indicator (RSSI), a signal-to-noise rate (SNR), or any combination thereof, of one or more replies received from the one or more tags.

Clause 51. The RTR of any of clauses 49 to 50, wherein based on the reply rate being below a first reply rate threshold, the reply power being below a first reply power threshold, or any combination thereof: the second BLF is lower than the first BLF; the second number of subcarrier cycles per symbol is higher than the first number of subcarrier cycles per symbol; or any combination thereof.

Clause 52. The RTR of any of clauses 49 to 51, wherein based on the reply rate being above a second reply rate threshold, the reply power being above a second reply power threshold, or any combination thereof: the second BLF is higher than the first BLF; the second number of subcarrier cycles per symbol is lower than the first number of subcarrier cycles per symbol; or any combination thereof.

Clause 53. A remote tag reader (RTR) comprising: means for communicating with one or more tags based on one or more first parameters associated with a first communication mode, wherein the one or more first parameters comprise a first backscatter link frequency (BLF), a first number of subcarrier cycles per symbol, or any combination thereof; means for determining a second communication mode for communicating with the one or more tags based on a reply rate or a reply power associated with the first communication mode; and means for sending, to the one or more tags, one or more second parameters associated with the second communication mode, wherein the one or more second parameters comprise a second BLF, a second number of subcarrier cycles per symbol, or any combination thereof.

Clause 54. The RTR of clause 53, wherein: the reply rate corresponds to a number of replies received from the one or more tags divided by a number of replies expected from the one or more tags; and the reply power corresponds to a received signal strength indicator (RSSI), a signal-to-noise rate (SNR), or any combination thereof, of one or more replies received from the one or more tags.

Clause 55. The RTR of any of clauses 53 to 54, wherein based on the reply rate being below a first reply rate threshold, the reply power being below a first reply power threshold, or any combination thereof: the second BLF is lower than the first BLF; the second number of subcarrier cycles per symbol is higher than the first number of subcarrier cycles per symbol; or any combination thereof.

Clause 56. The RTR of any of clauses 53 to 55, wherein based on the reply rate being above a second reply rate threshold, the reply power being above a second reply power threshold, or any combination thereof: the second BLF is higher than the first BLF; the second number of subcarrier cycles per symbol is lower than the first number of subcarrier cycles per symbol; or any combination thereof.

Clause 57. A non-transitory computer-readable medium storing computer-executable instructions that, when executed by a remote tag reader (RTR), cause the RTR to: communicate with one or more tags based on one or more first parameters associated with a first communication mode, wherein the one or more first parameters comprise a first backscatter link frequency (BLF), a first number of subcarrier cycles per symbol, or any combination thereof; determine a second communication mode for communicating with the one or more tags based on a reply rate or a reply power associated with the first communication mode; and send, to the one or more tags, one or more second parameters associated with the second communication mode, wherein the one or more second parameters comprise a second BLF, a second number of subcarrier cycles per symbol, or any combination thereof.

Clause 58. The non-transitory computer-readable medium of clause 57, wherein: the reply rate corresponds to a number of replies received from the one or more tags divided by a number of replies expected from the one or more tags; and the reply power corresponds to a received signal strength indicator (RSSI), a signal-to-noise rate (SNR), or any combination thereof, of one or more replies received from the one or more tags.

Clause 59. The non-transitory computer-readable medium of any of clauses 57 to 58, wherein based on the reply rate being below a first reply rate threshold, the reply power being below a first reply power threshold, or any combination thereof: the second BLF is lower than the first BLF; the second number of subcarrier cycles per symbol is higher than the first number of subcarrier cycles per symbol; or any combination thereof.

Clause 60. The non-transitory computer-readable medium of any of clauses 57 to 59, wherein based on the reply rate being above a second reply rate threshold, the reply power being above a second reply power threshold, or any combination thereof: the second BLF is higher than the first BLF; the second number of subcarrier cycles per symbol is lower than the first number of subcarrier cycles per symbol; or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

1. A remote tag reader (RTR) comprising:
one or more memories;
one or more transceivers; and
one or more processors communicatively coupled to the one or more memories and the one or more transceivers, the one or more processors, either alone or in combination, configured to:
determine a communication mode for communicating with one or more remote tags based on:
one or more activity levels of one or more radios associated with the RTR;
an amount of interference determined by the RTR;
a type of RTR procedure; or
any combination thereof;
send, via the one or more transceivers, to the one or more tags, one or more parameters associated with the determined communication mode, wherein the one or more parameters indicate a backscatter link frequency (BLF), a number of subcarrier cycles per symbol, or any combination thereof; and
communicate with the one or more tags based on the determined communication mode.

2. The RTR of claim 1, wherein:
the RTR is a user equipment (UE) that comprises an RTR radio and the one or more radios;
the communicating with the one or more tags is via the RTR radio; and
the one or more radios comprise a wireless wide area network (WWAN) radio, a wireless local area network (WLAN) radio, a Bluetooth radio, a global navigation satellite system (GNSS) radio, or any combination thereof.

3. The RTR of claim 1, wherein the one or more processors, either alone or in combination, are further configured to:
determine a resource availability level at the RTR based on the one or more activity levels of the one or more radios;
select the one or more parameters based on the resource availability level, wherein the one or more processors configured to select comprises the one or more processors, either alone or in combination, configured to:
select a first BLF or a first number of subcarrier cycles per symbol, based on determining a first resource availability level; or
select a second BLF that is lower than the first BLF, a second number of subcarrier cycles per symbol that is higher than the first number of subcarrier cycles per symbol, or any combination thereof, based on determining a second resource availability that is lower than the first resource availability level.

4. The RTR of claim 3, wherein the one or more activity levels comprise:
one or more first activity levels corresponding to an acquisition mode of a GNSS radio, a tracking mode of the GNSS radio, and a power-optimized mode of the GNSS radio; and
a second activity level corresponding to a non-operating mode of the GNSS radio.

5. The RTR of claim 3, wherein the one or more activity levels comprise:
one or more first activity levels corresponding to one or more operating modes of a radio of the one or more radios; and
a second activity level corresponding to a non-operating mode of the radio.

6. The RTR of claim 1, wherein the one or more processors, either alone or in combination, are further configured to determine the communication mode for communicating the one or more tags based on the type of RTR procedure, wherein the type of RTR procedure comprises an inventory procedure, an access procedure, or a write procedure.

7. The RTR of claim 1, wherein the one or more processors, either alone or in combination, are further configured to:
determine a specific absorption rate (SAR) exposure level based on the one or more activity levels of the one or more radios;
select the one or more parameters based on the SAR exposure level, wherein the one or more processors configured to select comprises the one or more processors, either alone or in combination, configured to:
select a first BLF or a first number of subcarrier cycles per symbol, based on determining a first SAR exposure level; or
select a second BLF that is higher than the first BLF, a second number of subcarrier cycles per symbol that is lower than the first number of subcarrier cycles per symbol, or any combination thereof, based on determining a second SAR exposure level that is higher than the first SAR exposure level.

8. The RTR of claim 1, wherein the one or more processors, either alone or in combination, are further configured to:
determine a self-interference level caused by a continuous wave (W) transmission of an RTR radio of the RTR;
select the one or more parameters based on the self-interference level, wherein the one or more processors configured to select comprises the one or more processors, either alone or in combination, configured to:
select a first BLF or a first number of subcarrier cycles per symbol, based on determining a first self-interference level; or
select a second BLF that is lower than the first BLF, a second number of subcarrier cycles per symbol that is higher than the first number of subcarrier cycles per symbol, or any combination thereof, based on determining a second self-interference level that is higher than the first self-interference level.

9. The RTR of claim 1, wherein the one or more processors, either alone or in combination, are further configured to:
determine an interference level caused by noise, a radio jammer, or any combination thereof;
select the one or more parameters based on the interference level, wherein the one or more processors configured to select comprises the one or more processors, either alone or in combination, configured to:
select a first BLF or a first number of subcarrier cycles per symbol, based on determining a first interference level; or
select a second BLF that is lower than the first BLF, a second number of subcarrier cycles per symbol that is higher than the first number of subcarrier cycles per symbol, or any combination thereof, based on determining a second interference level that is higher than the first interference level.

10. The RTR of claim 9, wherein the one or more processors, either alone or in combination, are further configured to:
monitor, during a first time duration T1 following a RTR transmission or a second time duration T2 following a RTR reception, one or more frequencies.

11. The RTR of claim 1, wherein the one or more parameters are sent to the one or more tags in a query command.

12. A method of wireless communication performed by a remote tag reader (RTR), comprising:
determining a communication mode for communicating with one or more remote tags based on:
one or more activity levels of one or more radios associated with the RTR;
an amount of interference determined by the RTR;
a type of RTR procedure; or
any combination thereof;
sending, to the one or more tags, one or more parameters associated with the determined communication mode, wherein the one or more parameters indicate a backscatter link frequency (BLF), a number of subcarrier cycles per symbol, or any combination thereof; and
communicating with the one or more tags based on the determined communication mode.

13. The method of claim 12, wherein:
the RTR is a user equipment (UE) that comprises an RTR radio and the one or more radios;
the communicating with the one or more tags is via the RTR radio; and
the one or more radios comprise a wireless wide area network (WWAN) radio, a wireless local area network (WLAN) radio, a Bluetooth radio, a global navigation satellite system (GNSS) radio, or any combination thereof.

14. The method of claim 12, further comprising:
determining a resource availability level at the RTR based on the one or more activity levels of the one or more radios;
selecting the one or more parameters based on the resource availability level, wherein the selecting comprises:
selecting a first BLF or a first number of subcarrier cycles per symbol, based on determining a first resource availability level; or
selecting a second BLF that is lower than the first BLF, a second number of subcarrier cycles per symbol that is higher than the first number of subcarrier cycles per symbol, or any combination thereof, based on determining a second resource availability that is lower than the first resource availability level.

15. The method of claim 14, wherein the one or more activity levels comprise:
one or more first activity levels corresponding to an acquisition mode of a GNSS radio, a tracking mode of the GNSS radio, and a power-optimized mode of the GNSS radio; and
a second activity level corresponding to a non-operating mode of the GNSS radio.

16. The method of claim 14, wherein the one or more activity levels comprise:
one or more first activity levels corresponding to one or more operating modes of a radio of the one or more radios; and
a second activity level corresponding to a non-operating mode of the radio.

17. A remote tag reader (RTR) comprising:
one or more memories;
one or more transceivers; and
one or more processors communicatively coupled to the one or more memories and the one or more transceivers, the one or more processors, either alone or in combination, configured to:
communicate with one or more tags based on one or more first parameters associated with a first communication mode, wherein the one or more first parameters comprise a first backscatter link frequency (BLF), a first number of subcarrier cycles per symbol, or any combination thereof;
determine a second communication mode for communicating with the one or more tags based on a reply rate or a reply power associated with the first communication mode; and
send, via the one or more transceivers, to the one or more tags, one or more second parameters associated with the second communication mode, wherein the one or more second parameters comprise a second BLF, a second number of subcarrier cycles per symbol, or any combination thereof.

18. The RTR of claim 17, wherein:
the reply rate corresponds to a number of replies received from the one or more tags divided by a number of replies expected from the one or more tags; and
the reply power corresponds to a received signal strength indicator (RSSI), a signal-to-noise rate (SNR), or any combination thereof, of one or more replies received from the one or more tags.

19. The RTR of claim 17, wherein based on the reply rate being below a first reply rate threshold, the reply power being below a first reply power threshold, or any combination thereof:
the second BLF is lower than the first BLF;
the second number of subcarrier cycles per symbol is higher than the first number of subcarrier cycles per symbol; or
any combination thereof.

20. The RTR of claim 17, wherein based on the reply rate being above a second reply rate threshold, the reply power being above a second reply power threshold, or any combination thereof:
the second BLF is higher than the first BLF;
the second number of subcarrier cycles per symbol is lower than the first number of subcarrier cycles per symbol; or
any combination thereof.
